(19) United States
(12) Patent Application Publication
(10) Pub. No.: US 2017/0197490 A1
(43) Pub. Date: Jul. 13, 2017

(54) REFRIGERATION CYCLE DEVICE

(71) Applicant: DENSO CORPORATION, Kariya-city, Aichi-pref. (JP)

(72) Inventors: Norihiko ENOMOTO, Kariya-city (JP); Yoshiki KATOH, Kariya-city (JP); Kengo SUGIMURA, Kariya-city (JP); Nobuharu KAKEHASHI, Kariya-city (JP)

(73) Assignee: DENSO CORPORATION, Kariya-City, Aichi-Pref (JP)

(21) Appl. No.: 15/314,117

(22) PCT Filed: Jun. 2, 2015
(86) PCT No.: PCT/JP2015/002785

§ 371 Date: Nov. 28, 2016

(30) Foreign Application Priority Data
Jun. 18, 2014 (JP) 2014-125306

(51) Int. Cl. B60H 1/00

(52) U.S. Cl. CPC B60H 1/00899; B60H 1/00485; B60H 1/00342; B60H 1/004; B60H 2001/00928; B60H 2001/00957

(57) ABSTRACT

A refrigeration cycle device includes: a low-temperature side pump that draws and discharges a low-temperature side heat medium; a compressor that draws, compresses, and discharges a refrigerant; a heat radiation device that dissipates heat from a high-pressure refrigerant discharged from the compressor; a decompression device that decompresses the high-pressure refrigerant having heat dissipated by the heat radiation device; an internal heat exchanger that exchanges heat between the high-pressure refrigerant flowing out of the heat radiation device and the low-pressure refrigerant flowing out of a heat-medium cooler; a low-pressure refrigerant temperature sensing portion that detects or senses a temperature in connection with a temperature of the low-pressure refrigerant having heat exchanged in the internal heat exchanger; and a superheat-degree control unit that controls a degree of superheat of the low-pressure refrigerant having heat exchanged in the internal heat exchanger, based on the temperature detected or sensed by the low-pressure refrigerant temperature sensing portion.

### CROSS REFERENCE TO RELATED APPLICATION

The application is based on a Japanese Patent Application No. 2014-125306 filed on Jun. 18, 2014, the contents of which are incorporated herein by reference in its entirety.

### FIELD OF THE INVENTION

The present disclosure of the present invention relates to a refrigeration cycle device including an internal heat exchanger.

### BACKGROUND ART

Conventionally, for example, Patent Document 1 discloses the structure of a refrigeration cycle device that uses carbon dioxide as a refrigerant and includes an internal heat exchanger. The internal heat exchanger is a heat exchanger that exchanges heat between a refrigerant from a radiator and a refrigerant from an evaporator.

When using carbon dioxide as the refrigerant, a high-pressure side pressure in the refrigeration cycle could reach a critical pressure or more in summer, leading to an increase in power consumption by a compressor, thus degrading a coefficient of performance (COP) of the refrigeration cycle.

In the related art, the internal heat exchanger exchanges heat between the refrigerant from the radiator and the refrigerant from the evaporator, thereby suppressing the degradation of the coefficient of performance (COP) of the refrigeration cycle.

The evaporator in the related art is a refrigerant-air heat exchanger that exchanges heat between cooling air and a low-pressure refrigerant decompressed and expanded by an expansion mechanism.

### RELATED ART DOCUMENT

### Patent Document

### Patent Document 1: Japanese Unexamined Patent Application Publication No. 2008-122034

### SUMMARY OF INVENTION

The present applicant has studied a refrigeration cycle device (hereinafter referred to a studied example) that exchanges heat between a refrigerant in the refrigerant cycle and a coolant (heat medium) in an evaporator, then allowing the coolant, which is cooled by the evaporator, to exchange heat with ventilation air in an air-cooling heat exchanger, thereby cooling the ventilation air.

Since in the studied example, the evaporator does not exchange heat with the ventilation air, even if the refrigerant leaks in the evaporator, the leaking refrigerant can be prevented from being fed to a space to be ventilated together with the ventilation air.

In the studied example, however, to cool the ventilation air with the same amount of heat as that in the related art, the temperature of a coolant in the air-cooling heat exchanger needs to be set at the same level as that in the evaporator of the related art.

Suppose the evaporator takes the degree of superheat in the same manner as in the related art. In the evaporator of the related art, a difference in temperature between the ventilation air and refrigerant is so large that a predetermined degree of superheat can be obtained through a relatively small heat-exchange area. On the other hand, in the evaporator of the studied example, the degree of superheat needs to be taken from between the coolant having a much lower temperature than the ventilation air and the refrigerant. For this reason, the evaporator of the studied example has difficulty in gaining the adequate degree of superheat, and might be inferior in controllability (suppression of variations and stability) for variations in load on the refrigeration cycle.

When intending to gain the degree of superheat using a small difference in temperature between the refrigerant and coolant, the temperature of refrigerant in the evaporator needs to be decreased to enhance the temperature difference between the refrigerant and coolant, thereby increasing the amount of heat exchange. In such a case, the density of the refrigerant drawn into the compressor might be reduced to degrade the coefficient of performance (COP) of the refrigeration cycle.

The present disclosure has been made in view of the foregoing matter, and it is an object of the present disclosure to improve the controllability for variations in the load and the coefficient of performance (COP) of a refrigeration cycle in a refrigeration cycle device that includes a heat-medium cooler for cooling a heat medium with a refrigerant and a heat medium-air heat exchanger for exchanging heat between the heat medium cooled by the heat-medium cooler and air.

To obtain the above object, a refrigeration cycle device includes: a low-temperature side pump that draws and discharges a low-temperature side heat medium; a compressor that draws, compresses, and discharges a refrigerant; a heat radiation device that dissipates heat from the high-pressure refrigerant discharged from the compressor; a decompression device that decompresses the high-pressure refrigerant having heat dissipated by the heat radiation device; a heat-medium cooler that cools the low-temperature side heat medium by exchanging heat between the low-pressure refrigerant decompressed by the decompression device and the low-temperature side heat medium; a heat medium-air heat exchanger that exchanges heat between the heat medium cooled by the heat-medium cooler and air; an internal heat exchanger that exchanges heat between the high-pressure refrigerant flowing out of the heat radiation device and the low-pressure refrigerant flowing out of the heat-medium cooler; a low-pressure refrigerant temperature sensing portion that detects or senses a temperature in connection with a temperature of the low-pressure refrigerant having heat exchanged in the internal heat exchanger; and a superheat-degree control unit that controls a degree of superheat of the low-pressure refrigerant having heat exchanged in the internal heat exchanger, based on the temperature detected or sensed by the low-pressure refrigerant temperature sensing portion.

With the arrangement described above, the degree of superheat is taken by the internal heat exchanger, thereby making it possible to surely take the degree of superheat without decreasing the refrigerant temperature, compared to when taking a degree of superheat by the heat-medium cooler. This is because a difference in temperature between the high-pressure refrigerant and the low-pressure refrigerant in the internal heat exchanger is larger than that between the low-pressure refrigerant and the low-temperature side heat-medium in the heat-medium cooler.

Accordingly, the controllability for variations in the load and the coefficient of performance of the refrigeration cycle can be improved by taking the degree of superheat in the internal heat exchanger.

For example, the superheat-degree control unit may decrease the degree of superheat of the low-pressure refrigerant having heat exchanged in the internal heat exchanger, when the temperature or pressure of the low-pressure side refrigerant becomes lower.

Thus, the degree of superheat of the low-pressure refrigerant having heat exchanged in the internal heat exchanger is decreased under the condition in which the temperature or pressure of the low-pressure side refrigerant is low, whereby a gas-liquid two-phase region also occurs on the low-pressure refrigerant side in the internal heat exchanger, thereby improving the heat exchange capacity of the internal heat exchanger. In other words, the degree of supercooling on the high-pressure refrigerant side in the internal heat exchanger becomes larger. When the degree of supercooling becomes larger, the amount of liquid-phase refrigerant in the heat-medium cooler can be increased to enhance the heat absorption capacity of the heat-medium cooler. Therefore, the refrigeration cycle can improve its coefficient of performance.

Furthermore, the degree of supercooling of the high-pressure refrigerant having heat exchanged in the internal heat exchanger can be increased, thus decreasing the refrigerant pressure in the heat dissipation device, and thereby improving the efficiency of the compressor. Therefore, the refrigeration cycle can improve its coefficient of performance.

### BRIEF DESCRIPTION OF DRAWINGS

FIG. 1 is an entire configuration diagram of a refrigeration cycle device according to a first embodiment.

FIG. 2 is a configuration diagram of a refrigerant circuit in the refrigeration cycle device in the first embodiment.

FIG. 3 is a characteristic diagram of an expansion valve in opening the valve in the first embodiment.

FIG. 4 is a block diagram showing an electric control unit of the refrigeration cycle device in the first embodiment.

FIG. 5 is a diagram for explaining an air-heating mode of the refrigeration cycle device in the first embodiment.

FIG. 6 is a diagram for explaining an air-cooling mode of the refrigeration cycle device in the first embodiment.

FIG. 7 is a Mollier diagram showing a cycling behavior in the air-heating mode of the refrigeration cycle device in the first embodiment.

FIG. 8 is a Mollier diagram showing a cycling behavior in the air-cooling mode of the refrigeration cycle device in the first embodiment.

FIG. 9 is an entire configuration diagram of a refrigeration cycle device according to a second embodiment.

FIG. 10 is an entire configuration diagram of a refrigerant circuit in a refrigeration cycle device according to a third embodiment.

FIG. 11 is an entire configuration diagram of a refrigerant circuit in a refrigeration cycle device according to a fourth embodiment.

FIG. 12 is a perspective view of an expansion valve, a coolant cooler, and an internal heat exchanger according to a fifth embodiment.

FIG. 13 is a perspective view of an expansion valve, a coolant cooler, and an internal heat exchanger according to a sixth embodiment.

FIG. 14 is a perspective, transparent view of the expansion valve, the coolant cooler, and the internal heat exchanger in the sixth embodiment.

FIG. 15 is a cross-sectional view taken along the line XV-XV of FIG. 13.

FIG. 16 is an exploded cross-sectional view of the expansion valve, the coolant cooler, and the internal heat exchanger in the sixth embodiment.

### DESCRIPTION OF EMBODIMENTS

In the following, embodiments will be described with reference to the accompanying drawings. Note that in the respective embodiments below, the same or equivalent parts are indicated by the same reference characters throughout the figures.

### First Embodiment

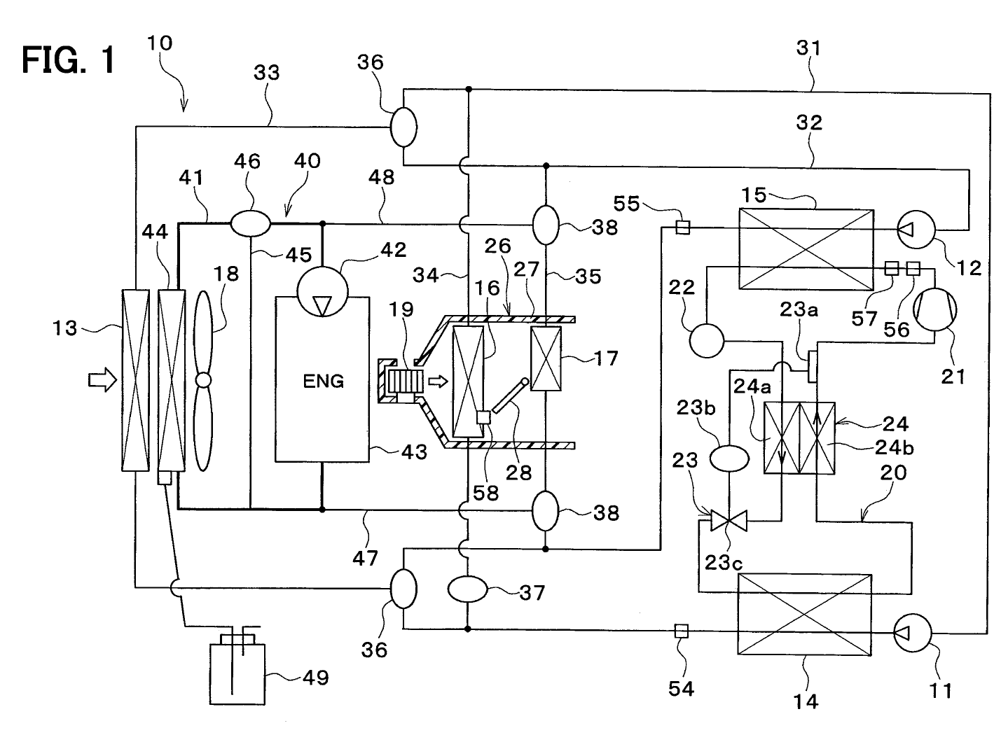

A refrigeration cycle device 10 shown in FIG. 1 is used to air-condition the interior of a vehicle to an appropriate temperature. In this embodiment, the refrigeration cycle device 10 is applied to a hybrid vehicle that obtains a driving force for traveling from both an engine (internal combustion engine) and a traveling electric motor.

The hybrid vehicle of this embodiment is configured as a plug-in hybrid vehicle that can charge the battery (vehicle-mounted battery) mounted on the vehicle, with power supplied from an external power source (commercial power source) during stopping of the vehicle. For example, a lithium-ion battery can be used as the battery.

The driving force output from the engine is used not only to cause the vehicle to travel, but also to operate a power generator. The power generated by the power generator and the power supplied from the external power source can be stored in the battery. The power stored in the battery is supplied not only to the traveling electric motor, but also to various vehicle-mounted devices, including electric components included in the refrigeration cycle device 10.

As shown in FIG. 1, the refrigeration cycle device 10 includes a low-temperature side pump 11, a high-temperature side pump 12, a radiator 13, a radiator three-way valve 36, a coolant cooler 14, a coolant heater 15, a cooler core 16, and a heater core 17.

Each of the low-temperature side pump 11 and the high-temperature side pump 12 serves as a coolant pump that draws and discharges a coolant (heat medium), and is configured of an electric pump. The coolant is a fluid as the heat medium. In this embodiment, the coolant suitable for use can include a liquid containing at least ethylene glycol, dimethylpolysiloxane, or a nanofluid, and an antifreezing solution.

The radiator 13, the coolant cooler 14, the coolant heater 15, the cooler core 16, and the heater core 17 are coolant circulation devices (heat-medium circulation devices) through which the coolant circulates.

The radiator 13 is a coolant-outside air heat exchanger (heat medium-outside air heat exchanger) that exchanges heat between the coolant and the outside air (vehicle exterior air). The radiator 13 receives the outside air blown by an exterior blower 18. The exterior blower 18 is a blower that blows the outside air to the radiator 13. The exterior blower 18 is an electric blower that includes a blower fan driven by an electric motor (blower motor).

The radiator 13 and the exterior blower 18 are disposed at the forefront of the vehicle. Thus, traveling air can hit the radiator 13 during traveling of the vehicle.

When the coolant passing through the coolant cooler 14 flows through the radiator 13, the coolant temperature is set lower than the outside air temperature, whereby the radiator 13 functions as a heat-absorption heat exchanger that absorbs heat from the outside air into the coolant. In this case, by allowing the coolant passing through the coolant heater 15 to flow through the heater core 17, the refrigeration cycle device 10 acts as a heat pump heater that heats the ventilation air in the heater core 17 by absorbing heat from the outside air.

When the coolant passing through the coolant heater 15 flows through the radiator 13, the coolant temperature is set higher than the outside air temperature, whereby the radiator 13 functions as a heat-dissipation heat exchanger that dissipates heat from the coolant into the outside air. In this case, by allowing the coolant passing through the coolant cooler 14 to flow through the cooler core 16, the refrigeration cycle device 10 acts as a cooler that cools the ventilation air by the cooler core 16 and dissipates waste heat into the outside air at the radiator when cooling the air.

The coolant cooler 14 is a low-pressure side heat exchanger (heat-medium cooler) that cools the coolant by exchanging heat between the coolant and a low-pressure side refrigerant in a refrigerant circuit 20 (refrigeration cycle). The coolant cooler 14 can cool the coolant to a temperature lower than the outside air temperature.

The coolant heater 15 is a high-pressure side heat exchanger (heat-medium heater) that heats the coolant by exchanging heat between the coolant and a high-pressure side refrigerant in the refrigerant circuit 20. The coolant heater 15 is a radiator that dissipates heat from the high-pressure side refrigerant in the refrigerant circuit 20.

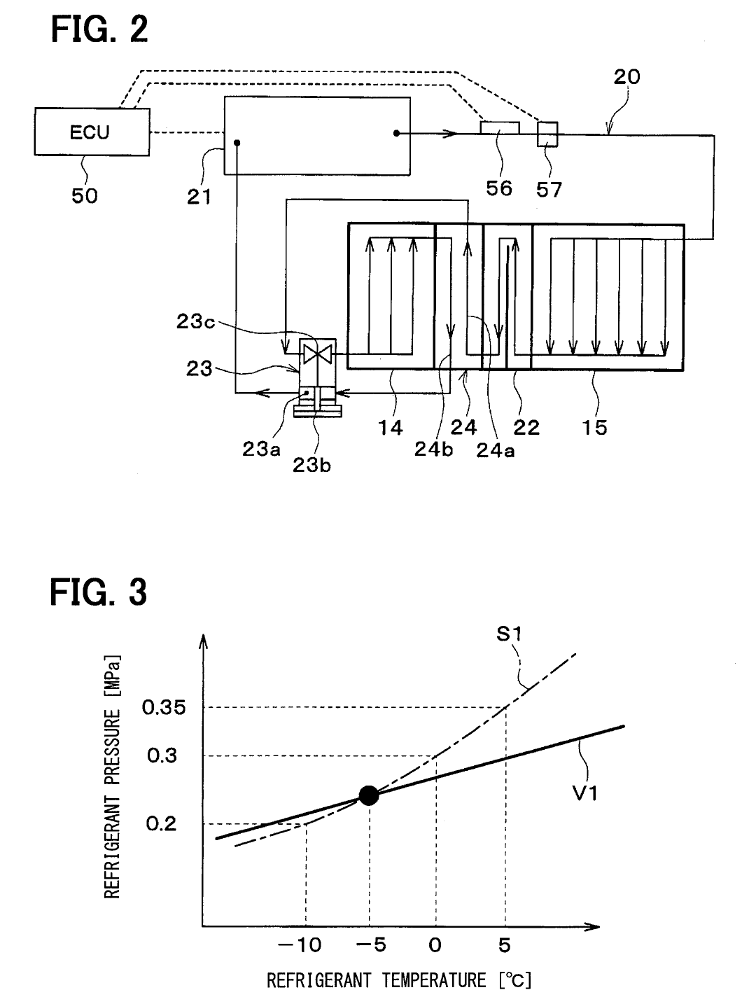

As shown in FIG. 2, the refrigerant circuit 20 is a vapor-compression refrigerator that includes a compressor 21, the coolant heater 15, a liquid reservoir 22, an expansion valve 23, the coolant cooler 14, and an internal heat exchanger 24.

The refrigerant circuit 20 in this embodiment forms a subcritical refrigeration cycle in which a high-pressure side refrigerant pressure does not exceed the critical pressure of the refrigerant, using a fluorocarbon refrigerant (HFC134a, HFO1234yf, etc.) as the refrigerant.

The compressor 21 is an electric compressor driven by power supplied from the battery, or a compressor driven by a belt. The compressor 21 draws, compresses, and discharges the refrigerant in the refrigerant circuit 20.

The coolant heater 15 is a condenser that condenses a high-pressure side refrigerant by exchanging heat between the coolant and the high-pressure side refrigerant discharged from the compressor 21. The liquid reservoir 22 is a gas-liquid separator that separates a gas-liquid two-phase refrigerant flowing out of the coolant heater 15 into a gas-phase refrigerant and a liquid-phase refrigerant, and then flows the separated liquid-phase refrigerant to the expansion valve 23 side.

The expansion valve 23 is a decompression device that decompresses and expands a liquid-phase refrigerant flowing out of a high-pressure side refrigerant flow path 24a of the internal heat exchanger 24. The expansion valve 23 is a thermal expansion valve (mechanical expansion valve) that has a temperature sensing portion 23a and drives a valve body by a mechanical mechanism, such as a diaphragm 23b.

The temperature sensing portion 23a detects the degree of superheat of the refrigerant on the outlet side in a low-pressure side refrigerant flow path 24b of the internal heat exchanger 24 (hereinafter referred to as a low-pressure side outlet refrigerant in the internal heat exchanger 24) based on the temperature and pressure of the low-pressure side outlet refrigerant in the internal heat exchanger 24. The temperature sensing portion 23a is a low-pressure refrigerant temperature sensing portion (low-pressure refrigerant temperature detector) that senses (detects) the temperature of the low-pressure side outlet refrigerant in the internal heat exchanger 24.

The degree of superheat of the low-pressure side outlet refrigerant in the internal heat exchanger 24 may be detected or estimated based on the pressure of the inlet-side refrigerant in the coolant cooler 14 and the refrigerant pressure after decompression by the expansion valve 23.

The mechanical mechanism, such as the diaphragm 23b, changes an area (opening degree) of a throttle flow path 23c by driving its valve body such that the degree of superheat of the low-pressure side outlet refrigerant in the internal heat exchanger 24 is within a predetermined range.

The mechanical mechanism, such as the diaphragm 23b, is a superheat-degree control unit that controls the degree of superheat of the low-pressure refrigerant having its heat exchanged by the internal heat exchanger 24. The throttle flow path 23c is a decompression device that decompresses the high-pressure refrigerant that has its heat dissipated in the coolant heater 15.

Gas refrigerant is charged into the temperature sensing portion 23a. The composition of the gas refrigerant charged in the temperature sensing portion 23a is determined depending on the properties, including the target pressure (temperature) and degree of superheat of the low-pressure side outlet refrigerant in the internal heat exchanger 24.

The gas charged into the temperature sensing portion 23a for use is a mixture of, for example, fluorocarbon refrigerant (HFC134a, HFO1234yf, etc.) and He (helium) or N₂ (nitrogen), thereby allowing the expansion valve 23 to exhibit the cross-charge characteristics.

Here, the term cross-charge characteristics as used herein means that as shown in FIG. 3, a valve-opening characteristic V1 of the expansion valve 23 is set to have the relationship that intersects (crosses) a saturation line S1 of the refrigerant circulating in the cycle at a predetermined temperature T1.

That is, the degree of superheat is not taken when the pressure of a low-pressure refrigerant flowing out of the internal heat exchanger 24 is lower than the saturated pressure of the refrigerant at the predetermined temperature T1. In an example shown in FIG. 3, the predetermined temperature T1 is −5° C. The predetermined temperature T1 may be 5° C. or lower.

The valve-opening characteristic V1 of the expansion valve 23 corresponds to the relationship between the temperature and pressure of the low-pressure side outlet refrigerant in the internal heat exchanger 24 that are controlled by the expansion valve 23. The valve-opening characteristic V1 is determined by the kind and ratio of gases charged in the temperature sensing portion 23a and a preset pressure of a spring urging the valve body of the expansion valve 23.

The coolant cooler 14 shown in FIGS. 1 and 2 is an evaporator that evaporates a low-pressure refrigerant by exchanging heat between the coolant and the low-pressure refrigerant decompressed and expanded by the expansion valve 23. The gas-phase refrigerant evaporated at the coolant cooler 14 is drawn into and compressed by the compressor 21.

The internal heat exchanger 24 is a heat exchanger that exchanges heat between the high-pressure refrigerant flowing out of the liquid reservoir 22 and the low-pressure refrigerant flowing out of the coolant cooler 14.

The internal heat exchanger 24 has the high-pressure side refrigerant flow path 24a and the low-pressure side refrigerant flow path 24b. The high-pressure side refrigerant flow path 24a is a flow path through which the high-pressure side refrigerant flowing out of the coolant heater 15 passes. The low-pressure side refrigerant flow path 24b is a flow path through which the low-pressure side refrigerant flowing out of the coolant cooler 14 passes.

In the example shown in FIG. 2, the coolant cooler 14, the internal heat exchanger 24, the liquid reservoir 22, and the coolant heater 15 are integrated together. Specifically, the coolant cooler 14, the internal heat exchanger 24, the liquid reservoir 22, and the coolant heater 15 are integrated and bonded to each other with brazing.

The cooler core 16 shown in FIG. 1 is an air-cooling heat exchanger that cools ventilation air into the vehicle interior by exchanging heat between the coolant and the ventilation air into the vehicle interior. The cooler core 16 is a coolant-air heat exchanger (heat medium-air heat exchanger) that exchanges heat between the coolant cooled by the coolant cooler 14 and the air.

The heater core 17 is an air-heating heat exchanger that heats ventilation air into the vehicle interior by exchanging heat between the coolant and the ventilation air into the vehicle interior. The heater core 17 is a radiator that dissipates heat from the coolant heated by the high-pressure side refrigerant, in the coolant heater 15.

The heater core 17 is disposed on the leeward side of the ventilation air relative to the cooler core 16. When the cooler core allows the coolant cooled by the coolant cooler 14 to pass therethrough, the ventilation air cooled by the cooler core 16 is reheated by the heater core 17, thereby performing air-heating while adjusting the temperature of the ventilation air and dehumidifying the ventilation air.

The cooler core 16 and the heater core 17 receive inside air (vehicle interior air), outside air, or a mixed air of the inside air and outside air blown by an interior blower 19. The interior blower 19 is a blower that blows air toward the vehicle interior (space to be air-conditioned). The interior blower 19 is an electric blower that includes a centrifugal multiblade fan (sirocco fan) to be driven by an electric motor (blower motor).

The cooler core 16, the heater core 17, and the interior blower 19 are accommodated in a casing 27 of an interior air-conditioning unit 26 in a vehicle air conditioner. The interior air-conditioning unit 26 is disposed inside a dashboard (instrumental panel) at the foremost portion of the vehicle interior. The casing 27 forms an outer shell of the interior air-conditioning unit.

The casing 27 forms an air passage for the ventilation air to be blown into the vehicle interior. The casing 27 is formed of resin (for example, polypropylene) with some elasticity and excellent strength. Within the casing 27, the heater core 17 is disposed on the downstream side of the air flow relative to the cooler core 16.

An air mix door 28 is disposed between the cooler core 16 and the heater core 17 within the casing 27. The air mix door 28 serves as a blown-air temperature adjustment portion (air flow-rate ratio adjustment portion) that adjusts the ratio of the flow rate of the air flowing through the heater core 17 to the flow rate of the air bypassing the heater core 17, thereby adjusting the temperature of the blown air into the vehicle interior. The air mix door 28 also serves as an air flow-rate adjustment portion that adjusts the flow rate of air passing through the heater core 17.

The air mix door 28 is, for example, a revolving plate-shaped door, a slidable door, or the like, and driven by an electric actuator (not shown).

The low-temperature side pump 11 is disposed in a low-temperature side pump flow path 31. The high-temperature side pump 12 is disposed in a high-temperature side pump flow path 32. The radiator 13 is disposed in a radiator flow path 33.

The cooler core 16 is disposed in a cooler-core flow path 34. The heater core 17 is disposed in a heater-core flow path 35.

The low-temperature side pump flow path 31, the high-temperature side pump flow path 32, and the radiator flow path 33 are connected together with the radiator three-way valve 36. The radiator three-way valve 36 is an electric switching valve that switches the flow path by an electric mechanism.

The radiator three-way valve 36 is a flow path switch that switches between a state in which the low-temperature side pump flow path 31 communicates with the radiator flow path 33 and a state in which the high-temperature side pump flow path 32 communicates with the radiator flow path 33.

Switching control of the flow path in the radiator three-way valve 36 selectively controls whether the refrigeration cycle device 10 performs a heat-pump air-heating operation or an air-cooling operation.

The refrigeration cycle device 10 switches the flow direction of the coolant by the radiator three-way valve 36 to enable switching between the air-heating operation and the air-cooling operation without switching or reversing the flow direction of the refrigerant in the circuit through which the refrigerant flows.

The radiator three-way valve 36 is a coolant flow-rate adjustment portion (heat-medium flow-rate adjustment portion) for adjusting the flow rate of the coolant flowing through the radiator 13. The flow rate of coolant through the radiator 13 is adjusted to thereby regulate a heat absorption or dissipation capacity of the radiator 13, so that the temperature in the low-temperature side pump flow path 31 or the coolant temperature in the high-temperature side pump flow path 32 is controlled to approach the target temperature.

In addition to the radiator 13, when additionally installing a device for cooling or heating the coolant, the radiator three-way valve 36 may be a multi-way valve capable of switching to a flow path to the added device (or the device for cooling or heating the coolant).

The cooler-core flow path 34 is connected to the low-temperature side pump flow path 31. A flow-path on-off valve 37 is disposed in the cooler-core flow path 34. The flow-path on-off valve 37 is a flow-path on-off device that opens and closes the cooler-core flow path 34. The flow-path on-off valve 37 is an electric on-off valve that opens and closes the flow path by the electric mechanism.

The heater-core flow path 35 is connected to the high-temperature side pump flow path 32. The heater-core flow path 35 is connected to an engine cooling circuit 40 (heat-medium circuit) via an engine-cooling-circuit three-way valve 38.

The engine-cooling-circuit three-way valve 38 is a flow path switch that switches between a state in which the engine cooling circuit 40 communicates with the heater-core flow path 35 and a state in which the engine cooling circuit 40 does not communicate with the heater-core flow path 35. The engine-cooling-circuit three-way valve 38 is an electric switching valve that switches the flow path by an electric mechanism.

All the radiator three-way valve 36, the flow-path on-off valve 37, and the engine-cooling-circuit three-way valve 38 may be incorporated in one casing, or alternatively some of these valves may be collectively incorporated in one casing. All these valves may share a driving mechanism or alternatively some of them may share one.

The engine cooling circuit 40 includes a circulation flow path 41 for allowing the circulation of the coolant. The circulation flow path 41 configures a main flow path in the engine cooling circuit 40. In the circulation flow path 41, an engine pump 42, an engine 43, and an engine radiator 44 are arranged in series in this order.

The engine pump 42 is an electric pump that draws and discharges the coolant. The engine pump 42 may be rotatably driven by the engine via a pulley, a belt, etc. The engine 43 is a heat generator that generates waste heat.

The engine radiator 44 is a radiator (heat medium-outside air heat exchanger) that dissipates heat from the coolant into the outside air by exchanging heat between the coolant and the outside air. The coolant at a temperature equal to or lower than the outside air temperature is allowed to flow through the engine radiator 44, thereby enabling heat absorption from the outside air into the coolant in the engine radiator 44.

The exterior blower 18 blows the outside air toward the engine radiator 44. The engine radiator 44 is disposed at the foremost portion of the vehicle on the downstream side in the outside-air flow direction relative to the radiator 13.

The circulation flow path 41 is connected to a radiator bypass flow path 45. The radiator bypass flow path 45 is a radiator bypass portion that allows the coolant to bypass the engine radiator 44 in the engine cooling circuit 40.

A thermostat 46 is disposed in a connection portion between the radiator bypass flow path 45 and the circulation flow path 41. The thermostat 46 is a coolant-temperature responsive valve that is constructed of a mechanical mechanism designed to open and close a coolant flow path by displacing a valve body using a thermo wax (temperature sensing member) that has its volume changeable depending on its temperature.

Specifically, when the temperature of coolant is below a predetermined temperature (for example, lower than 80° C.), the thermostat 46 opens the radiator bypass flow path 45. When the temperature of coolant exceeds the predetermined temperature (for example, 80° C. or higher), the thermostat 46 closes the radiator bypass flow path 45.

The circulation flow path 41 is connected to the heater-core flow path 35 via a connection flow path 48. A reserve tank 49 is connected to the engine radiator 44. The reserve tank 49 is a coolant reservoir that stores therein extra coolant.

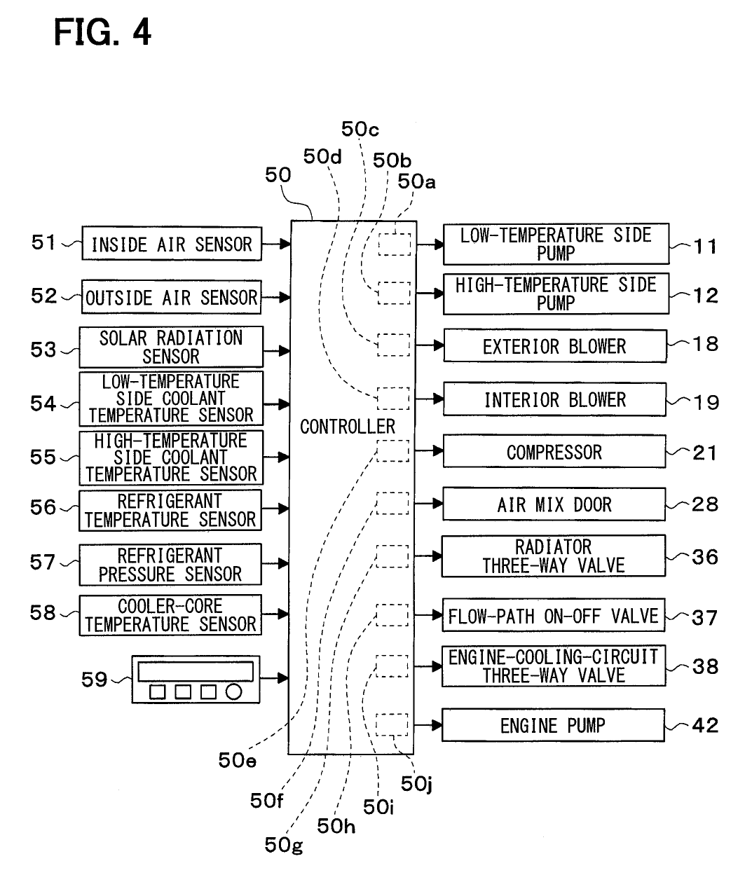

A controller 50 shown in FIG. 4 is configured of a known microcomputer, including CPU, ROM, and RAM, and a peripheral circuit thereof. The controller performs various computations and processing based on air-conditioning control programs stored in the ROM to thereby control the operations of the low-temperature side pump 11, high-temperature side pump 12, exterior blower 18, interior blower 19, compressor 21, air mix door 28, radiator three-way valve 36 (medium flow adjustment portion), and the like, which are connected to the output side of the controller.

The controller 50 is integrally structured with control units for controlling various control target devices connected to the output side of the controller. A structure (hardware and software) adapted to control the operation of each of the control target devices serves as the control unit for controlling the operation of the corresponding control target device.

A structure (hardware and software) of the controller 50 for controlling the operation of the low-temperature side pump 11 is configured as a low-temperature side coolant flow-rate control unit 50a (low-temperature side heat-medium flow-rate control unit).

A structure (hardware and software) of the controller 50 for controlling the operation of the high-temperature side pump 12 is configured as a high-temperature side coolant flow-rate control unit 50b (high-temperature side heat-medium flow-rate control unit).

A structure (hardware and software) of the controller 50 that controls the operation of the exterior blower 18 is configured as an exterior blower control unit 50c (outside-air flow-rate control unit).

A structure (hardware and software) of the controller 50 that controls the operation of the interior blower 19 is configured as an interior blower control unit 50d (air flow-rate control unit).

A structure (hardware and software) of the controller 50 that controls the operation of the compressor 21 is configured as a refrigerant flow-rate control unit 50e.

A structure (hardware and software) of the controller 50 that controls the operation of the air mix door 28 is configured as an air mix door control unit 50f (air flow-rate ratio control unit).

A structure (hardware and software) of the controller 50 that controls the operation of the radiator three-way valve 36 is configured as a radiator three-way valve control unit 50g (flow-path switching control unit).

A structure (hardware and software) of the controller 50 that controls the operation of the flow-path on-off valve 37 is configured as a flow-path on-off valve control unit 50h.

A structure (hardware and software) of the controller 50 that controls the operation of the engine-cooling-circuit three-way valve 38 is configured as an engine-cooling-circuit three-way valve control unit 50i (flow-path switching control unit).

A structure (hardware and software) of the controller 50 for controlling the operation of the engine pump 42 is configured as an engine pump control unit 50j (high-temperature side heat-medium flow-rate control unit).

The low-temperature side coolant flow-rate control unit 50a, high-temperature side coolant flow-rate control unit 50b, exterior blower control unit 50c, interior blower control unit 50d, refrigerant flow-rate control unit 50e, air mix door control unit 50f, radiator three-way valve control unit 50g, flow-path on-off valve control unit 50h, engine-cooling-circuit three-way valve control unit 50i, and engine pump control unit 50j may be provided separately from the controller 50.

Detection signals from a group of sensors are input to the input side of the controller 50. The sensor group includes an inside air sensor 51, an outside air sensor 52, a solar radiation sensor 53, a low-temperature side coolant temperature sensor 54, a high-temperature side coolant temperature sensor 55, a refrigerant temperature sensor 56, a refrigerant pressure sensor 57, and a cooler-core temperature sensor 58.

The inside air sensor 51 is a detector (inside-air temperature detector) that detects the temperature of the inside air (vehicle interior temperature). The outside air sensor 52 is a detector (outside-air temperature detector) that detects the temperature of the outside air (vehicle exterior temperature). The solar radiation sensor 53 is a detector (solar radiation amount detector) that detects the amount of solar radiation into the vehicle interior.

The low-temperature side coolant-temperature sensor 54 is a detector (low-temperature side heat-medium temperature detector) that detects the temperature of the coolant flowing through a low-temperature side coolant circuit C1 (for example, the temperature of the coolant flowing out of the coolant cooler 14).

The high-temperature side coolant-temperature sensor 55 is a detector (high-temperature side heat-medium temperature detector) that detects the temperature of the coolant flowing through a high-temperature side coolant circuit C2 (for example, the temperature of the coolant flowing out of the coolant heater 15).

The refrigerant temperature sensor 56 is a detector (refrigerant temperature detector) that detects the temperature of refrigerant in the refrigerant circuit 20. The temperature of refrigerant in the refrigerant circuit 20 detected by the refrigerant temperature sensor 56 includes, for example, the temperature of a high-pressure side refrigerant discharged from the compressor 21, the temperature of a low-pressure side refrigerant drawn into the compressor 21, the temperature of a low-pressure side refrigerant decompressed and expanded by the expansion valve 23, and the temperature of a low-pressure side refrigerant exchanging heat with the coolant cooler 14.

The refrigerant pressure sensor 57 is a detector (refrigerant pressure detector) that detects a refrigerant pressure in the refrigerant circuit 20 (for example, the pressure of the high-pressure side refrigerant discharged from the compressor 21 and the pressure of the low-pressure side refrigerant drawn into the compressor 21).

The cooler-core temperature sensor 58 is a detector (cooler-core temperature detector) that detects the surface temperature of the cooler core 16. The cooler-core temperature sensor 58 is, for example, a fin thermistor for detecting the temperature of a heat exchange fin in the cooler core 16, a coolant-temperature sensor for detecting the temperature of the coolant flowing through the cooler core 16, or the like.

The inside air temperature, the outside air temperature, the coolant temperature, the refrigerant temperature, and the refrigerant pressure may be estimated based on detected values of various physical quantities.

For example, the temperature of the coolant in the low-temperature side coolant circuit C1 may be calculated based on at least one of the outlet refrigerant pressure in the coolant cooler 14, the suction refrigerant pressure in the compressor 21, the pressure of the low-pressure side refrigerant in the refrigerant circuit 20, the temperature of the low-pressure side refrigerant in the refrigerant circuit 20, an air-heating operation time, and the like.

For example, the temperature of the coolant in the high-temperature side coolant circuit C2 may be calculated based on at least one of the outlet refrigerant pressure in the coolant heater 15, the discharge refrigerant pressure in the compressor 21, the pressure of the high-pressure side refrigerant in the refrigerant circuit 20, the temperature of the high-pressure side refrigerant in the refrigerant circuit 20, and the like.

Operation signals from an operation panel 59 are input to the input side of the controller 50. The operation panel 59 is disposed near an instrumental panel in the vehicle interior. The operation panel 59 is provided with various operation switches. Specifically, various operation switches provided on the operation panel 59 include an air-conditioning operation switch for requesting the air-conditioning of the vehicle interior, and a vehicle-interior temperature setting switch for setting the temperature of the vehicle interior.

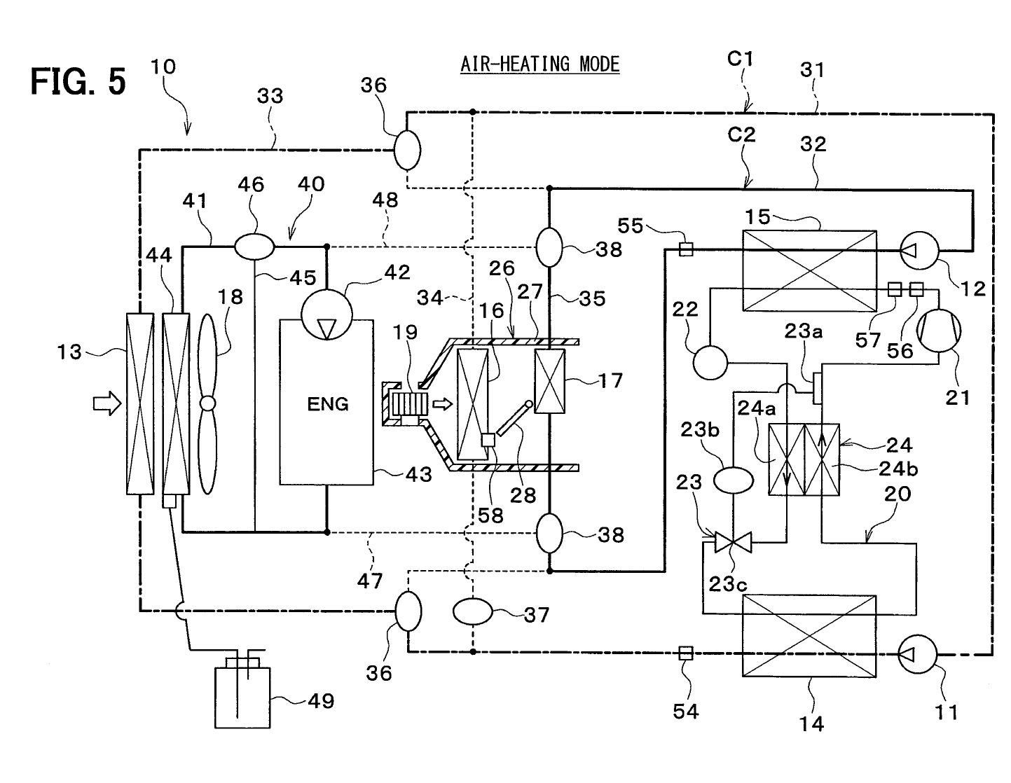

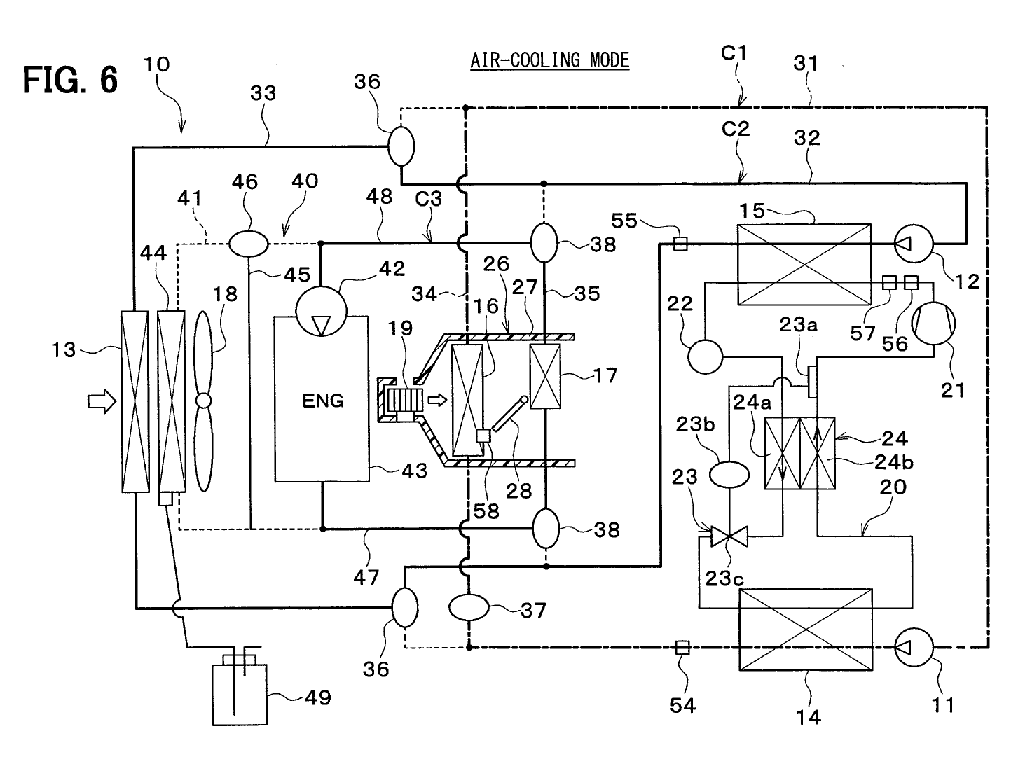

Next, the operation with the above-mentioned structure will be described. The controller 50 switches between an air-heating mode shown in FIG. 5 and an air-cooling mode shown in FIG. 6 by controlling the operations of the radiator three-way valve 36 and the engine-cooling-circuit three-way valve 38.

In the air-heating mode shown in FIG. 5, a low-temperature side coolant circuit C1 indicated by a thick alternate long and short dash line and a high-temperature side coolant circuit C2 indicated by a thick solid line are formed.

The low-temperature side coolant circuit C1 is a circuit that allows the coolant to circulate through the low-temperature side pump 11 to the coolant cooler 14, the radiator 13, and the low-temperature side pump 11 in this order. The high-temperature side coolant circuit C2 is a circuit that allows the coolant to circulate through the high-temperature side pump 12 to the coolant heater 15, the heater core 17, and the high-temperature side pump 12 in this order.

When switching to the air-heating mode shown in FIG. 5, the controller 50 operates the low-temperature side pump 11, the high-temperature side pump 12, and the compressor 21, thereby allowing the refrigerant to circulate through the refrigerant circuit 20 and also allowing the coolant to independently circulate through the low-temperature side coolant circuit C1 and the high-temperature side coolant circuit C2.

The coolant cooler 14 causes the refrigerant in the refrigerant circuit 20 to absorb heat from the coolant in the low-temperature side coolant circuit C1, thereby cooling the coolant in the low-temperature side coolant circuit C1. The refrigerant absorbing heat from the coolant at the coolant cooler 14 in the refrigerant circuit 20 dissipates heat at the coolant heater 15 into the coolant in the high-temperature side coolant circuit C2. In this way, the coolant in the high-temperature side coolant circuit C2 is heated.

The coolant heated by the coolant heater 15 in the high-temperature side coolant circuit C2 dissipates heat in the heater core 17, into the ventilation air blown by the interior blower 19. Thus, the ventilation air into the vehicle interior is heated, thereby enabling air-heating of the vehicle interior.

The coolant cooled by the coolant cooler 14 in the low-temperature side coolant circuit C1 absorbs heat in the radiator 13 from the outside air blown by the exterior blower 18. Therefore, a heat-pump operation for pumping up the heat from the outside air can be achieved.

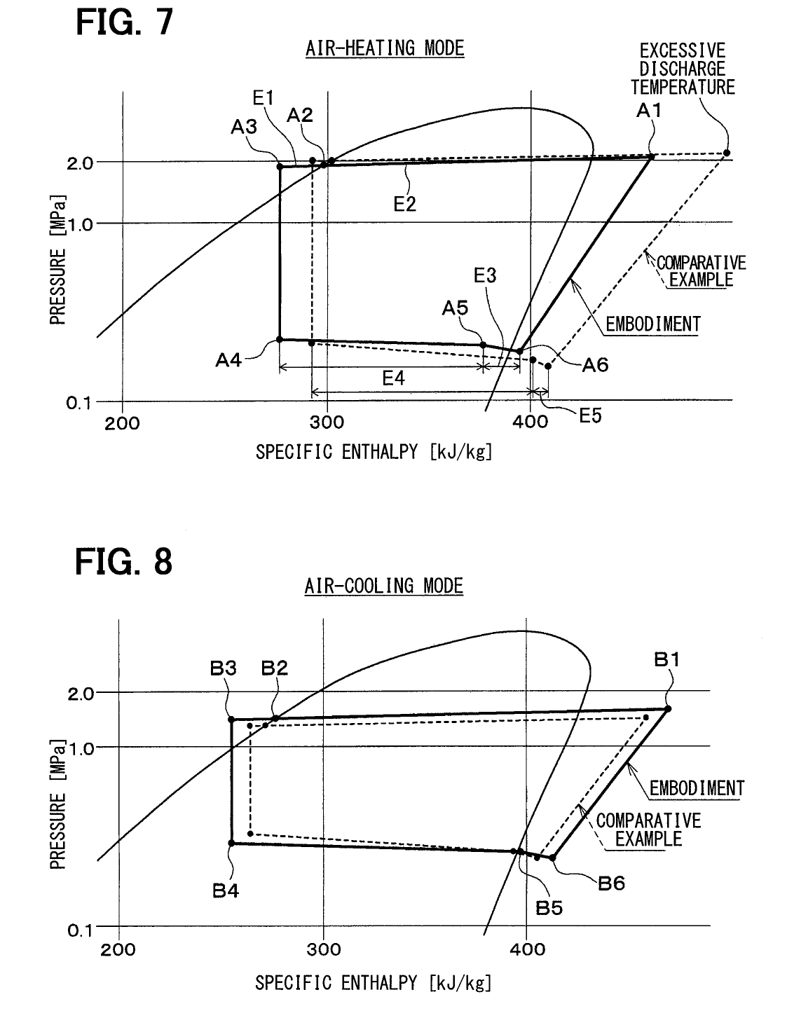

FIG. 7 is a Mollier diagram showing a behavior of the refrigeration cycle in the air-heating mode. In FIG. 7, part E2 (from point A1 to point A2) indicates the state of the refrigerant in heat exchange at the coolant heater 15. In FIG. 7, part E1 (from point A2 to point A3) indicates the state of the refrigerant in heat exchange at the high-pressure side refrigerant flow path 24a of the internal heat exchanger 24. In FIG. 7, part E4 (from point A4 to point A5) indicates the state of the refrigerant in heat exchange at the coolant cooler 14. In FIG. 7, part E3 (from point A5 to point A6) indicates the state of the refrigerant in heat exchange at the low-pressure side refrigerant flow path 24b of the internal heat exchanger 24.

A dashed line in FIG. 7 illustrates a comparative example. In the comparative example, the expansion valve 23 adjusts a throttle passage area such that the refrigerant on the outlet side of the coolant cooler 14 has adequate degree of superheat. Thus, the low-pressure side refrigerant in the internal heat exchanger 24 becomes a gas phase. Part E5 indicates heat exchange at an internal heat exchanger in the comparative example.

In contrast, in this embodiment, the expansion valve 23 adjusts the throttle passage area such that the degree of superheat of the low-pressure side outlet refrigerant in the internal heat exchanger 24 becomes smaller than that in the comparative example.

In the internal heat exchanger 24 of this embodiment, heat is exchanged between the low-pressure side refrigerant and the high-temperature refrigerant, which are significantly different in temperature. Thus, the internal heat exchanger 24 can achieve the sufficient heat exchange even through a small heat-exchange area, and adjust the throttle passage area to decrease the degree of superheat of the low-pressure side outlet refrigerant in the internal heat exchanger 24.

As the degree of superheat on the low-pressure side outlet of the internal heat exchanger 24 is decreased, the degree of superheat of a low-pressure side inlet refrigerant in the internal heat exchanger 24 becomes lower. When the degree of superheat of the low-pressure side refrigerant is less than a predetermined degree, a gas-liquid two-phase region occurs in the low-pressure side refrigerant, enhancing the heat absorption capacity of the low-pressure side refrigerant in the internal heat exchanger 24. That is, the heat exchange capacity inside the internal heat exchanger 24 is increased. This is because the thermal conductivity of a part through which the gas-liquid two-phase refrigerant flows is much higher than that of a gas-phase refrigerant.

Consequently, the outlet side refrigerant in the high-pressure side refrigerant flow path 24a of the internal heat exchanger 24 (hereinafter referred to as an outlet side high-pressure refrigerant in the internal heat exchanger 24) takes a large degree of supercooling. Thus, the dryness of the gas-liquid two-phase refrigerant flowing into the coolant cooler 14 can be lowered, thereby enhancing the heat absorption capacity of the coolant cooler 14, improving the air-heating performance. That is, as the dryness of the gas-liquid two-phase refrigerant becomes lower, the pressure loss of the refrigerant in the coolant cooler 14 is reduced, while the amount of liquid refrigerant in the heat exchanger is increased, thereby improving the performance of the heat exchanger.

In the comparative example, the coolant cooler 14 takes therein the superheated region, and further, the internal heat exchanger 24 holds therein the superheated region, whereby the temperature of the refrigerant drawn into the compressor 21 increases to make the discharge refrigerant temperature excessively high, thus leading to breakage of the compressor 21 or a pipe or pipe seal member connected to the compressor 21.

Compared to the comparative example, this embodiment can suppress the discharge refrigerant temperature from the compressor 21 to a lower level, thereby preventing the breakage of the compressor 21 or the pipe or pipe seal member connected to the compressor 21.

In the comparative example, the increase in the temperature of the refrigerant discharged from the compressor 21 might lead to an increase in occupancy of the superheated region within the coolant heater 15 (part on the refrigerant inlet side of the coolant heater), degrading the heat dissipation capacity. To ensure the heat dissipation capacity, it is necessary to raise the discharge pressure of the compressor 21 by increasing the power of the compressor 21, thereby increasing the refrigerant temperature. Consequently, the discharge refrigerant temperature is further enhanced while degrading the coefficient of performance (COP) of the refrigeration cycle.

In the comparative example, the temperature and pressure of the refrigerant drawn into the compressor 21 become lower during an air-heating operation and the like, reducing the refrigerant density. In this state, in order to enhance the heat exchange capacity of the internal heat exchanger 24, the heat exchange area of the internal heat exchanger 24 needs to be increased. On the other hand, the temperature and pressure of the refrigerant drawn into the compressor 21 become relatively high during an air-cooling operation and the like, increasing the density of the refrigerant drawn by the compressor 21. As a result, the refrigerant flow rate is increased during the air-heating operation, and thus the excessive internal heat exchange might be performed because of the large heat exchange area, leading to an excessive increase in the temperature of the refrigerant discharged from the compressor 21. As mentioned above, the excessive degree of superheat might disadvantageously cause the increase in the temperature of the discharged refrigerant, whereby the sufficient internal heat exchanging performance cannot be exhibited during both the air-heating operation and the air-cooling operation.

In the air-cooling mode shown in FIG. 6, a low-temperature side coolant circuit C1 indicated by a thick alternate long and short dash line, a high-temperature side coolant circuit C2 indicated by a thick solid line, and an engine-heater core circuit C3 indicated by a thick solid line are formed.

The low-temperature side coolant circuit C1 is a circuit that allows the coolant to circulate from the low-temperature side pump 11 to the coolant cooler 14, the cooler core 16, and the low-temperature side pump 11 in this order.

The high-temperature side coolant circuit C2 is a circuit that allows the coolant to circulate from the high-temperature side pump 12 to the coolant heater 15, the radiator 13, and the high-temperature side pump 12 in this order.

The engine-heater core circuit C3 is a circuit that allows the coolant to circulate from the engine pump 42 to the engine 43, the heater core 17, and the engine pump 42 in this order.

When switching to the air-cooling mode shown in FIG. 6, the controller 50 operates the low-temperature side pump 11, the high-temperature side pump 12, the compressor 21, and the engine pump 42, thereby allowing the refrigerant to circulate through the refrigerant circuit 20 and also allowing the coolant to independently circulate through the low-temperature side coolant circuit C1, the high-temperature side coolant circuit C2, and the engine-heater core circuit C3.

The coolant cooler 14 causes the refrigerant in the refrigerant circuit 20 to absorb heat from the coolant in the low-temperature side coolant circuit C1, thereby cooling the coolant in the low-temperature side coolant circuit C1. The refrigerant absorbing heat from the coolant at the coolant cooler 14 in the refrigerant circuit 20 dissipates heat at the coolant heater 15 into the coolant in the high-temperature side coolant circuit C2. In this way, the coolant in the high-temperature side coolant circuit C2 is heated.

The coolant cooled by the coolant cooler 14 in the low-temperature side coolant circuit C1 absorbs heat in the cooler core 16 from the air blown by the interior blower 19. Thus, the ventilation air into the vehicle interior is cooled and dehumidified.

The coolant heated by the coolant heater 15 in the high-temperature side coolant circuit C2 dissipates heat in the radiator 13, into the outside air blown by the exterior blower 18.

In the heater core 17, the cool air cooled by the cooler core 16 is heated with the coolant in the engine-heater core circuit C3 heated by waste heat from the engine 43.

The controller 50 controls the air mix door 28, whereby the ratio of the flow rate of air flowing through the heater core 17 to that of air bypassing the heater core 17 is adjusted to thereby regulate the temperature of blown air to be blown into the vehicle interior. Thus, the vehicle interior can be either cooled or dehumidified and heated.

FIG. 8 is a Mollier diagram showing the behavior of the refrigeration cycle in the air-cooling mode. In FIG. 8, part from point B1 to point B2 indicates the state of the refrigerant in heat exchange at the coolant heater 15. In FIG. 8, part from point B2 to point B3 indicates the state of the refrigerant in heat exchange at the high-pressure side refrigerant flow path 24a of the internal heat exchanger 24. In FIG. 8, part from point B4 to point B5 indicates the state of the refrigerant in heat exchange at the coolant cooler 14. In FIG. 8, part from point B5 to point B6 indicates the state of the refrigerant in heat exchange at the low-pressure side refrigerant flow path 24b of the internal heat exchanger 24.

A dashed line in FIG. 8 illustrates a comparative example. In this embodiment, the expansion valve 23 adjusts the throttle passage area such that the degree of superheat of the low-pressure side outlet refrigerant in the internal heat exchanger 24 becomes larger than that in the comparative example.

Here, in the air-cooling mode, a low pressure in the cycle becomes higher. Thus, the flow rate of the refrigerant circulating through the refrigerant circuit 20 is increased.

The low-pressure side refrigerant in the refrigerant circuit 20 exchanges heat with air blown by the interior blower 19 via the coolant. A difference in the temperature between the coolant and refrigerant in the coolant cooler 14 is smaller than that between the coolant and ventilation air therein.

When intended to ensure the adequate degree of superheat under the conditions in which the flow rate of refrigerant is large and the difference in the temperature between the coolant and refrigerant is small in this way, the majority of a heat exchange region in the coolant cooler 14 becomes a superheated region, resulting in reduction in the heat absorption capacity. To ensure a predetermined degree of superheat as well as the required heat absorption capacity, it is necessary to enhance the heat exchange capacity by decreasing the refrigerant temperature. In this case, the power for the compressor 21 is increased to worsen the coefficient of performance (COP) of the refrigeration cycle.

Considering this point, in the embodiment, the internal heat exchanger 24 is adapted to mainly have a superheated region. Thus, the gas-liquid two-phase region of the refrigerant in the coolant cooler 14 is expanded, thereby enabling improvement of the heat absorption capacity and the air-cooling capacity.

When the internal heat exchanger 24 intends to take the degree of superheat, the internal heat exchanger 24 receives heat from the high-pressure side refrigerant at a high temperature, whereby the adequate degree of superheat can be ensured through a heat exchange area that is much smaller, compared to when the coolant cooler 14 takes the degree of superheat.

Further, the larger the degree of superheat taken by the low-pressure side refrigerant in the internal heat exchanger 24, the larger the degree of supercooling can be taken by the high-pressure side refrigerant in the internal heat exchanger 24. Thus, as long as the upper limit of the discharge temperature is allowable, the large degree of superheat is taken, and thereby the large degree of supercooling is ensured, making it possible to supply the refrigerant with a low dryness to the coolant cooler 14. As a result, the amount of liquid in the coolant cooler 14 is increased, thereby enabling improvement of the air-cooling performance.

Further, as the larger degree of superheat is taken by the low-pressure side refrigerant in the internal heat exchanger 24, the gas-liquid two-phase region inside the internal heat exchanger 24 is reduced, and further the dryness of the refrigerant at the outlet of the coolant cooler 14 is enhanced. This means that as the dryness of the refrigerant at the inlet is lower, and the dryness of the refrigerant at the outlet is higher, the difference in enthalpy of the refrigerant between the outlet and inlet of the coolant cooler becomes larger, leading to an increase in the amount of heat absorption.

As mentioned above, in this embodiment, the way to take the degree of superheat differs between the air-heating mode and the air-cooling mode. Specifically, the small degree of superheat is taken in the air-heating mode, whereas the large degree of superheat is taken in the air-cooling mode. The reason for this will be described below.

When intending to set the degree of superheat of the low-pressure side outlet refrigerant in the internal heat exchanger 24 to a predetermined level in the air-heating mode, because of the small density and small flow rate of the low-pressure side refrigerant, the adequate degree of superheat cannot be taken by the internal heat exchanger 24, and the gas-phase region of the refrigerant in the coolant cooler 14 is expanded to decrease the two-phase region. Thus, the heat absorption capacity of the coolant cooler 14 is reduced. Consequently, the air-heating performance is degraded.

Therefore, it is desirable that in the air-heating mode, the degree of superheat is controlled to be set as small as possible to thereby increase the two-phase region in the coolant cooler 14, thus enhancing the heat absorption capacity of the coolant cooler 14 to improve the air-heating capacity.

By taking the small degree of superheat in the air-heating mode, the two-phase region of the low-pressure side refrigerant in the internal heat exchanger 24 is also expanded to increase the amount of heat exchange in the internal heat exchanger 24, resulting in an increase in the degree of supercooling of the high-pressure side refrigerant in the internal heat exchanger 24.

Thus, the two-phase refrigerant entering the coolant cooler 14 can have its dryness decreased to improve the heat absorption capacity, while decreasing the discharge refrigerant temperature, so that an area occupied by the superheated region within the coolant heater 15 can be lessened. Furthermore, the degree of superheat of the refrigerant drawn into the compressor 21 can be reduced to a lower level, so that the power required to do an adiabatic compression work in the compressor 21 can be reduced. As a result, the air-heating capacity can be improved.

On the other hand, in the air-cooling mode, the large degree of supercooling of the outlet side high-pressure refrigerant in the internal heat exchanger 24 is taken, the dryness of the refrigerant at the inlet of the coolant cooler 14 is set lower, and the superheated region inside the internal heat exchanger 24 is increased, thereby reducing the rate of the two-phase region occupying the internal heat exchanger 24 to enhance the dryness of the refrigerant at the outlet of the coolant cooler 14, thus improving the air-cooling capacity. In other words, the enthalpy in the coolant cooler 14 is desired to be increased.

For this reason, preferably, the degree of superheat of the low-pressure side refrigerant in the internal heat exchanger 24 is taken as much as possible to increase the amount of heat exchange within the internal heat exchanger 24, thereby resulting in the adequate degree of supercooling of the outlet side high-pressure refrigerant in the internal heat exchanger 24.

Therefore, in this embodiment, the refrigeration cycle device 10 including the internal heat exchanger 24 is adapted to take the small degree of superheat in the air-heating mode and the large degree of superheat in the air-cooling mode. Thus, the occupancy of the two-phase region in the coolant cooler 14 and coolant heater 15 can be enlarged in both the air-heating mode and air-cooling mode, thus achieving the improvement of both the air-heating performance and the air-cooling performance.

In the air-heating mode, the supercharge degree is set smaller, increasing the density of gas refrigerant drawn into the compressor 21, making it easier for the compressor lubricating oil circulating through the refrigerant flow path to return to the compressor 21. Thus, the durability and reliability of the system can be improved. The amount of sealed oil can be reduced to improve the performance of the refrigeration cycle device 10.

By decreasing the degree of superheat in the air-heating mode, the compressor 21 is operated such that an operating region of the compressor 21 can be positioned on the side where a slope of an isentrope on the Mollier diagram becomes sharp. Thus, the degree of superheat (discharge temperature) on the discharge side of the compressor 21 can be decreased, compared to when the compressor is operated in a region where the slope of the isentrope becomes moderate, thereby improving the durability and efficiency of the compressor 21.

In this embodiment, the controller 50 serves as a heat-medium temperature control unit that controls the temperature of at least one of the low-temperature side coolant and the high-temperature side coolant.

When the coolant temperature in the high-temperature side coolant circuit C2 is determined or estimated to be lower than that in the low-temperature side coolant circuit C1, the controller 50 increases the coolant temperature in the high-temperature side coolant circuit C2, or decreases the coolant temperature in the low-temperature side coolant circuit C1.

Specifically, in the air-cooling mode, the controller 50 throttles or intermittently opens and closes the radiator three-way valve 36, thereby decreasing the flow rate (time-averaged flow rate) of the coolant flowing through the radiator 13, reducing the amount of heat transferred from the high-temperature side coolant circuit C2 to the outside air, resulting in an increase in the coolant temperature.

Furthermore, the controller 50 increases the flow rate of the discharge refrigerant (refrigerant discharge capacity) from the compressor 21, thereby decreasing the coolant temperature in the coolant cooler 14 and further the coolant temperature in the low-temperature side coolant circuit C1. At this time, the controller 50 throttles or intermittently opens and closes the flow-path on-off valve 37, thereby decreasing the flow rate (time-averaged flow rate) of the coolant flowing through the cooler core 16, thus preventing the decrease in the temperature of the blown air from the cooler core 16.

The cases in which the coolant temperature in the high-temperature side coolant circuit C2 is lower than that of the low-temperature side coolant circuit C1 can include, for example, in the air-cooling mode, a case in which the outside air temperature is low and the ventilation air is dehumidified by the cooler core 16.

When the outside air temperature is low (for example, 0° C.) and the ventilation air is dehumidified by the cooler core 16, the coolant temperature at the outlet of the cooler core 16 (in other words, the coolant temperature at the inlet of the coolant cooler 14) is at about 10 to 15° C., and the coolant temperature at the outlet of the radiator 13 (in other words, the coolant temperature at the inlet of the coolant heater 15) becomes approximately the outside air temperature.

In such a case, the temperature of the refrigerant exiting the coolant heater 15 is slightly higher (for example, 8° C.) than the outside air temperature, while the temperature of the refrigerant exiting the coolant cooler 14 is approximately at 10 to 15° C. Thus, heat flows from the low-pressure side refrigerant flow path 24b to the high-pressure side refrigerant flow path 24a in the internal heat exchanger 24, which is reverse to the normal flow of heat, making the refrigerant temperature at the outlet of the low-pressure side refrigerant flow path 24b of the internal heat exchanger 24 lower than that in the coolant cooler 14.

Since the expansion valve 23 operates to throttle its valve opening degree to take the degree of superheat by increasing the refrigerant temperature at the outlet of the low-pressure side refrigerant flow path in the internal heat exchanger 24, the coolant cooler 14 cannot exhibit the heat absorption capacity required for dehumidification because of a shortage of the flow rate of the refrigerant, or leads to a failure of the cycle control.

Thus, in this embodiment, when the coolant temperature in the high-temperature side coolant circuit C2 is determined or estimated to be lower than that in the low-temperature side coolant circuit C1, the coolant temperature in the high-temperature side coolant circuit C2 is increased by a predetermined degree, or the coolant temperature in the low-temperature side coolant circuit C1 is decreased by a predetermined degree, thereby preventing the dehumidifying capacity from becoming insufficient due to the shortage of the refrigerant flow rate, or the failure of the cycle control.

The coolant temperature in the high-temperature side coolant circuit C2 may be increased by a predetermined degree, or the coolant temperature in the low-temperature side coolant circuit C1 may be decreased by a predetermined degree in the following cases. The cases include not only when the coolant temperature in the high-temperature side coolant circuit C2 is determined or estimated to be lower than that in the low-temperature side coolant circuit C1, but also when a difference between the coolant temperature in the high-temperature side coolant circuit C2 and the coolant temperature in the low-temperature side coolant circuit C1 is determined or estimated to be smaller than a predetermined degree (e.g. 5° C.).

In this embodiment, the expansion valve 23 (specifically, the mechanical mechanism such as the diaphragm 23b) controls the degree of superheat of a low-pressure refrigerant having heat exchanged at the internal heat exchanger 24, based on the temperature detected by the temperature sensing portion 23a.

In this way, in the internal heat exchanger 24, the difference in temperature between the high-pressure refrigerant and the low-pressure refrigerant becomes larger, thereby making it possible to surely take the adequate degree of superheat by the internal heat exchanger 24. Thus, the control stability when the load on the refrigeration cycle varies can be improved.

In this embodiment, the expansion valve 23 (specifically, the mechanical mechanism, such as the diaphragm 23b), decreases the degree of superheat of the low-pressure refrigerant having heat exchanged at the internal heat exchanger 24 when the temperature or pressure of the low-pressure side refrigerant becomes lower.

Thus, under the condition in which the refrigerant evaporation temperature (saturated gas temperature) in the coolant cooler 14 is low, the degree of superheat of the low-pressure refrigerant having heat exchanged at the internal heat exchanger 24 is decreased, whereby the refrigerant in the coolant cooler 14 can be brought into the two-phase to enhance the heat absorption capacity of the coolant cooler 14.

Furthermore, the heat absorption capacity of the coolant cooler 14 can be enhanced to increase the degree of supercooling of the high-pressure refrigerant having heat exchanged in the internal heat exchanger 24, thus improving the heat dissipation capacity of the coolant heater 15.

By decreasing the degree of superheat of the low-pressure refrigerant having heat exchanged in the internal heat exchanger 24, the density of gas refrigerant drawn into the compressor 21 is increased to improve oil returnability of the compressor lubricating oil to the compressor 21.

Further, by decreasing the degree of superheat of the low-pressure refrigerant having heat exchanged in the internal heat exchanger 24, the compressor 21 can be operated in the operating region of the compressor 21 where the slope of the isentrope on the Mollier diagram becomes sharp, thereby decreasing the temperature of the refrigerant discharged from the compressor 21, thus improving the durability and efficiency of the compressor 21.

Under the condition in which the temperature of the low-pressure refrigerant having heat exchanged at the internal heat exchanger 24 is high, the degree of superheat of the low-pressure refrigerant after the heat exchange in the internal heat exchanger 24 becomes larger, so that the degree of supercooling of a high-pressure refrigerant having heat exchanged in the internal heat exchanger 24 can be increased. Thus, the amount of a refrigerant liquid in the coolant cooler 14 can be increased to improve the heat absorption capacity of the coolant cooler 14.

In this embodiment, the controller 50 decreases the temperature of the coolant flowing through the low-temperature side coolant circuit C1 (hereinafter referred to as a low-temperature side coolant), or increases the temperature of the coolant flowing through the high-temperature side coolant circuit C2 (hereinafter referred to as a high-temperature side coolant) in the following cases. The cases include when a difference in temperature between the high-temperature side and low-temperature side coolants is determined or estimated to be smaller than a predetermined degree, and when the temperature of the high-temperature side coolant is possibly lower than that of the low-temperature side coolant.

Thus, the heat can be prevented from being transferred from the low-pressure side refrigerant flow path 24b to the high-pressure side refrigerant flow path 24a in the internal heat exchanger 24, which can avoid the expansion valve 23 from excessively throttling its valve opening degree due to the lowered refrigerant temperature at the outlet of the low-pressure side refrigerant flow path 24b in the internal heat exchanger 24, compared to the refrigerant temperature at the outlet of the coolant cooler 14. Accordingly, the embodiment can suppress the shortage of the refrigerant flow rate or cooling capacity, or the failure of the cycle control.

For example, when the high-temperature side coolant flows through the radiator 13 (that is, in the air-cooling mode), the radiator three-way valve 36 decreases the flow rate of the high-temperature side coolant between the radiator 13 and the coolant heater 15, thereby making it possible to increase the temperature of the high-temperature side coolant.

In this embodiment, the radiator 13 exchanges heat between the low-temperature side coolant and the outside air, and the heater core 17 heats the ventilation air into the space to be air-conditioned (vehicle interior space), so that the space to be air-conditioned can be heated by the heat pump operation for pumping up the heat from the outside air.

In this embodiment, the radiator three-way valve 36 serves as a coolant switch (heat-medium switching device) that selectively switches between a state in which the high-temperature side coolant passing through the coolant heater 15 flows through the radiator 13, and a state in which the low-temperature side coolant passing through the coolant cooler 14 flows through the radiator 13.

Thus, this embodiment can switch between the heat-pump operation of absorbing heat from the outside air by the radiator 13 and the cooling operation of cooling the ventilation air by the cooler core 16.

In this embodiment, when the pressure of the low-pressure refrigerant having heat exchanged in the internal heat exchanger 24 is lower than the saturated pressure of the refrigerant at a predetermined temperature, the expansion valve 23 (specifically, the mechanical mechanism, such as the diaphragm 23b) is configured not to take the degree of superheat of the low-pressure refrigerant having heat exchanged in the internal heat exchanger 24.

Thus, the degree of superheat of the low-pressure refrigerant having heat exchanged in the internal heat exchanger 24 is not taken, thereby making it possible to further decrease the temperature of the refrigerant discharged from the compressor 21 while enhancing the heat absorbing performance of the coolant cooler 14 as well as the oil returnability to the compressor 21.

Specifically, in this embodiment, gas medium, which has its pressure raised with increasing temperature of the low-pressure refrigerant having heat exchanged in the internal heat exchanger 24, is charged into the temperature sensing portion 23a of the expansion valve 23. The mechanical mechanism such as the diaphragm 23b increases the opening degree of the throttle flow path 23c with the increasing pressure of the gas medium in the temperature sensing portion 23a. The temperature-pressure characteristics of the gas medium charged in the temperature sensing portion 23a differs from the temperature-pressure characteristics of the refrigerant.

The valve-opening characteristic V1 of the decompression device 23c by the mechanical mechanism such as the diaphragm 23b has cross-charge characteristics, that is, intersects a saturation line S1 of the refrigerant within a predetermined range of pressures.

Thus, as the refrigerant temperature becomes lower, the degree of superheat of the low-pressure refrigerant having heat exchanged in the internal heat exchanger 24 can be decreased.

### Second Embodiment

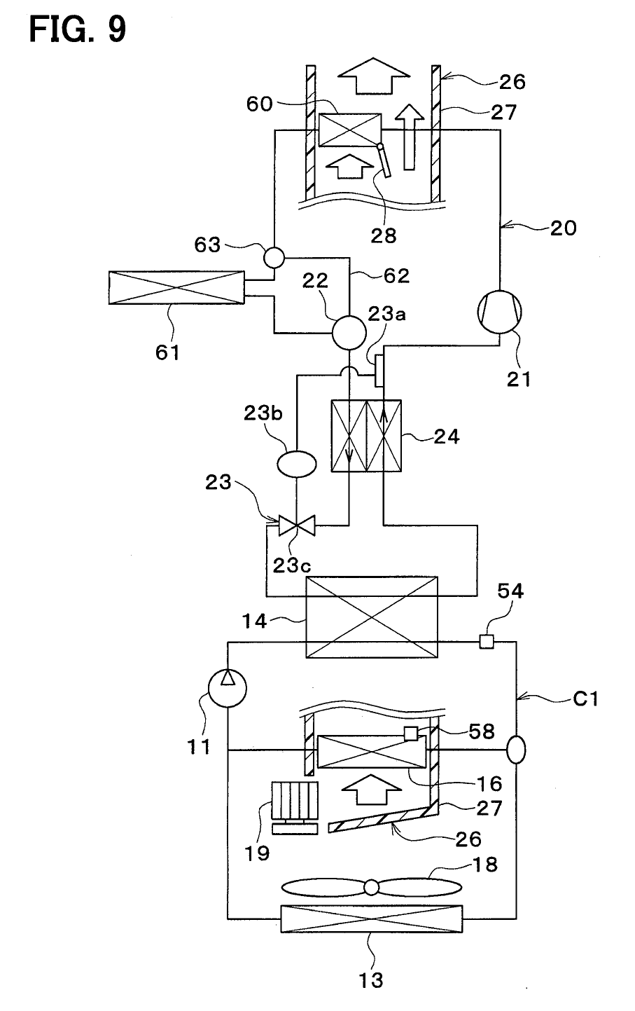

In the above-mentioned first embodiment, the high-pressure side refrigerant in the refrigerant circuit 20 heats the ventilation air into the vehicle interior via the coolant. On the other hand, in this embodiment, as shown in FIG. 9, the high-pressure side refrigerant in the refrigerant circuit 20 heats the ventilation air into the vehicle interior without the coolant.

The refrigerant circuit 20 has an interior capacitor 60, an exterior capacitor 61, an exterior capacitor bypass flow path 62, and a three-way valve 63. Each of the interior capacitor 60 and the exterior capacitor 61 is a radiator that dissipates heat from the high-pressure side refrigerant in the refrigerant circuit 20.

The interior capacitor 60 serves as a refrigerant-air heat exchanger that exchanges heat between the high-pressure side refrigerant discharged from the compressor 21 and the ventilation air into the vehicle interior. The interior capacitor 60 also serves as a condenser that condenses the high-pressure side refrigerant. The interior capacitor 60 further serves as an air-heating heat exchanger that heats the ventilation air into the vehicle interior.

The interior capacitor 60 is disposed within the casing 27 of the interior air-conditioning unit 26, and the heater core 17 is disposed on the downstream side of the air flow relative to the cooler core 16.

The exterior capacitor 61 is a condenser that condenses the high-pressure side refrigerant by exchanging heat between the high-pressure side refrigerant discharged from the compressor 21 and the outside air. The exterior capacitor 61 receives the outside air blown by the exterior blower 18.

The exterior capacitor bypass flow path 62 is a flow path through which the refrigerant in the refrigerant circuit 20 flows bypassing the exterior capacitor 61. The three-way valve 63 is a refrigerant flow switching device that switches between a state in which the refrigerant flows through the exterior capacitor 61 and a state in which the refrigerant flows through the exterior capacitor bypass flow path 62.

This embodiment can also exhibit the same functions and effects as those in the first embodiment.

### Third Embodiment

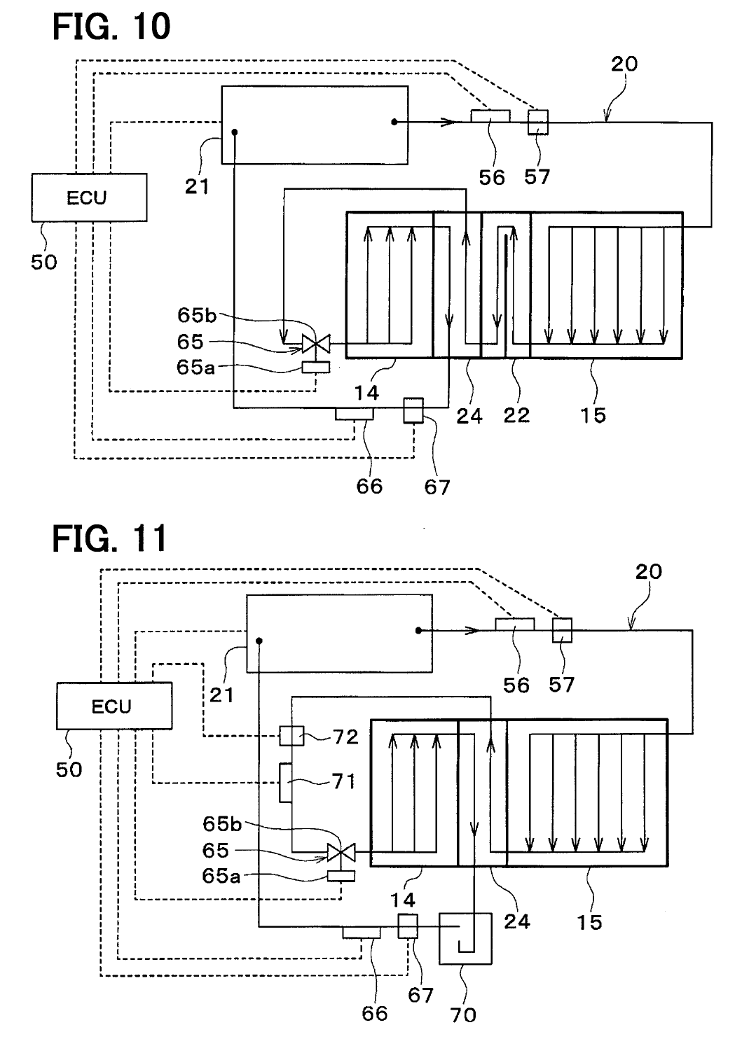

In the above-mentioned embodiments, the thermal expansion valve 23 is used as the decompression device that decompresses and expands the liquid-phase refrigerant flowing out of the coolant heater 15. On the other hand, as shown in FIG. 10, the expansion valve 23 uses an electric expansion valve 65 as the decompression device.

The electric expansion valve 65 changes the area (opening degree) of a throttle flow path 65b by an electric mechanism 65a. The throttle flow path 65b is a decompression device that decompresses the high-pressure refrigerant dissipating its heat in the coolant heater 15.

The operation of the electric mechanism 65a is controlled by the controller 50. The electric mechanism 65a and the controller 50 are superheat-degree control units that control the degree of superheat of the low-pressure refrigerant having its heat exchanged by the internal heat exchanger 24.

Detection signals from the refrigerant temperature sensor 66 and a refrigerant pressure sensor 67 are input to the input side of the controller 50.

The refrigerant temperature sensor 66 is a detector (low-pressure refrigerant temperature sensing portion, low-pressure refrigerant temperature detector) that detects the temperature of the low-pressure side outlet refrigerant in the internal heat exchanger 24. The refrigerant pressure sensor 67 is a detector (low-pressure refrigerant pressure detector) that detects the pressure of the low-pressure side outlet refrigerant in the internal heat exchanger 24.

The refrigerant pressure sensor 67 may be disposed in an arbitrary position in a low-pressure side pipe that leads from the outlet side of the electric expansion valve 65 to the suction side of the compressor 21 as long as a pressure loss in the refrigerant flow path of the internal heat exchanger 24 or coolant cooler 14 is known.

The controller 50 calculates a degree of superheat of the low-pressure side outlet refrigerant in the internal heat exchanger 24 based on the low-pressure refrigerant temperature detected by the refrigerant temperature sensor 66 and the low-pressure refrigerant pressure detected by the refrigerant pressure sensor 67. The controller 50 then adjusts the throttle passage area of the expansion valve 23 such that the calculated degree of superheat of the low-pressure side outlet refrigerant in the internal heat exchanger 24 is within a predetermined range.

Specifically, the controller 50 adjusts the throttle passage area of the expansion valve 23 to exhibit the cross-charge characteristics shown in FIG. 3.

In this embodiment, the controller 50 controls the operation of the electric mechanism 65a in the electric expansion valve 65 based on the refrigerant temperature detected by the refrigerant temperature sensor 66, thereby controlling the degree of superheat of the low-pressure refrigerant having heat exchanged in the internal heat exchanger 24. This embodiment can exhibit the same functions and effects as those in the first embodiment.

### Fourth Embodiment

In the above-mentioned embodiments, the refrigerant circuit 20 configures a receiver cycle that includes the liquid reservoir 22 arranged in a part through which the high-pressure refrigerant flows. On the other hand, as shown in FIG. 11, in this embodiment, the refrigerant circuit 20 configures an accumulator cycle that includes an accumulator 70 arranged in a part through which the low-pressure refrigerant flows.

The accumulator 70 is a refrigerant gas-liquid separator that separates the low-pressure refrigerant flowing out of the internal heat exchanger 24 into gas and liquid phases and allows the separated gas-phase refrigerant to flow out to the suction port side of the compressor 21. The accumulator 70 is also a refrigerant reservoir that stores therein the separated liquid-phase refrigerant as extra refrigerant.

Detection signals from a refrigerant temperature sensor 71 and a refrigerant pressure sensor 72 are input to the input side of the controller 50.

The refrigerant temperature sensor 71 is a detector (high-pressure refrigerant pressure detector) that detects the temperature of the outlet side high-pressure refrigerant in the internal heat exchanger 24. The refrigerant pressure sensor 72 is a detector (refrigerant pressure detector) that detects the pressure of the outlet side high-pressure refrigerant in the internal heat exchanger 24.

The controller 50 calculates a degree of supercooling of the outlet side high-pressure refrigerant in the internal heat exchanger 24 based on the refrigerant temperature detected by the refrigerant temperature sensor 71 and the refrigerant pressure detected by the refrigerant pressure sensor 72. The controller 50 then adjusts the throttle passage area of the expansion valve 65 such that the calculated degree of supercooling of the outlet side high-pressure refrigerant in the internal heat exchanger 24 is within a predetermined range.

That is, the controller 50 is a supercooling-degree control unit that controls the degree of supercooling of the outlet side high-pressure refrigerant in the internal heat exchanger 24.

When the degree of supercooling of the outlet side high-pressure refrigerant in the internal heat exchanger 24 is small, the amount of heat exchanged between the high-pressure and low-pressure refrigerants in the internal heat exchanger 24 is decreased, resulting in reduction in the degree of superheat of the low-pressure side outlet refrigerant in the internal heat exchanger 24.

When the degree of supercooling of the outlet side high-pressure refrigerant in the internal heat exchanger 24 is large, the amount of heat exchanged between the high-pressure and low-pressure refrigerants in the internal heat exchanger 24 is increased, resulting in the larger degree of superheat of the low-pressure side outlet refrigerant in the internal heat exchanger 24.

Therefore, this embodiment can also control the degree of superheat of the low-pressure side outlet refrigerant in the internal heat exchanger 24, like the above-mentioned embodiments.

In an example shown in FIG. 11, the expansion valve 65 is an electric expansion valve, while the expansion valve 65 may be a mechanical expansion valve.

In this embodiment, the controller 50 in the accumulator cycle controls the degree of supercooling of this high-pressure refrigerant having heat exchanged in the internal heat exchanger 24 based on the temperature of this refrigerant.

Thus, the degree of supercooling of the high-pressure refrigerant having heat exchanged in the internal heat exchanger 24 is controlled, whereby the amount of heat exchange by the internal heat exchanger 24 can be controlled, and further the degree of superheat of the low-pressure refrigerant having heat exchanged in the internal heat exchanger 24 can be controlled.

### Fifth Embodiment

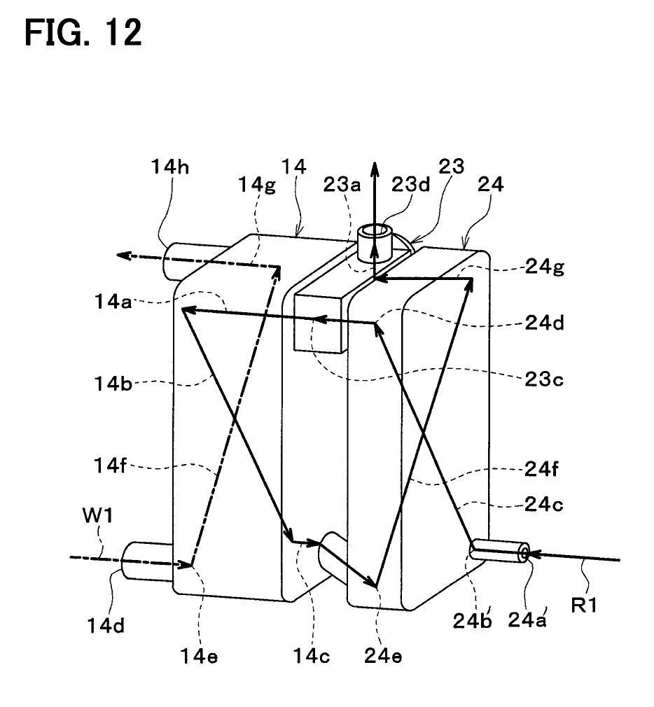

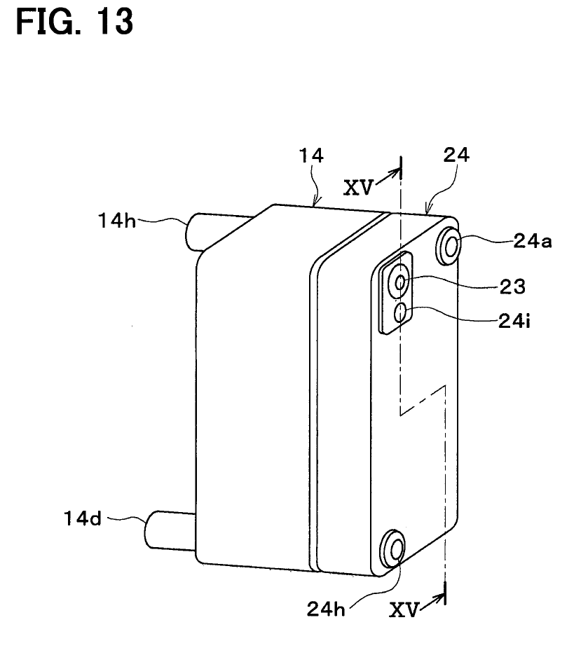

In this embodiment, as schematically shown in FIG. 12, the expansion valve 23 is sandwiched between and supported by the coolant cooler 14 and the internal heat exchanger 24.

The solid arrows illustrated in FIG. 12 show the flow of the refrigerant through the internal heat exchanger 24, the expansion valve 23, and the coolant cooler 14. As indicated by the solid arrows in FIG. 12, a high-pressure side refrigerant R1 flowing out of the coolant heater 15 flows through the high-pressure side refrigerant inlet 24a′ of the internal heat exchanger 24, a high-pressure side refrigerant distribution tank 24b′, a plurality of high-pressure side refrigerant flow paths 24c and high-pressure side refrigerant collection tank 24d, the throttle flow path 23c of the expansion valve 23, the refrigerant distribution tank 14a of the coolant cooler 14, a plurality of refrigerant flow paths 14b and refrigerant collection tank 14c, the low-pressure side refrigerant distribution tank 24e of the internal heat exchanger 24, a plurality of low-pressure side refrigerant flow paths 24f and low-pressure side refrigerant collection tank 24g, and the temperature sensing portion 23a and the low-pressure side refrigerant outlet 23d in the expansion valve 23, and it then flows out into the refrigerant suction port side of the compressor 21.

The high-pressure side refrigerant distribution tank 24b′ of the internal heat exchanger 24 distributes the high-pressure side refrigerant into the plurality of high-pressure side refrigerant flow paths 24c. The high-pressure side refrigerant collection tank 24d collects the high-pressure side refrigerants flowing through the plurality of high-pressure side refrigerant flow paths 24c.

The plurality of high-pressure side refrigerant flow paths 24c and the plurality of low-pressure side refrigerant flow paths 24f in the internal heat exchanger 24 configure the heat exchange portion that exchanges heat between the high-pressure side refrigerant and the low-pressure side refrigerant.

In the throttle flow path 23c of the expansion valve 23, the high-pressure side refrigerant having heat exchanged in the internal heat exchanger 24 is decompressed and expanded.

The refrigerant distribution tank 14a of the coolant cooler 14 distributes the low-pressure side refrigerant decompressed and expanded by the expansion valve 23 into a plurality of refrigerant flow paths 14b. The low-pressure side refrigerant collection tank 24g collects the low-pressure side refrigerants flowing through the plurality of refrigerant flow paths 14b.

The low-pressure side refrigerant distribution tank 24e of the internal heat exchanger 24 distributes the low-pressure side refrigerant having heat exchanged in the internal heat exchanger 24, into a plurality of low-pressure side refrigerant flow paths 24f. The low-pressure side refrigerant collection tank 24g collects the low-pressure side refrigerants flowing through the plurality of low-pressure side refrigerant flow paths 24f.

Alternate long and short dash arrows shown in FIG. 12 indicate the flows of the coolant in the coolant cooler 14. As indicated by the alternate long and short dash arrows in FIG. 12, the coolant W1 discharged from the low-temperature side pump 11 flows through a coolant inlet 14d of the coolant cooler 14, a coolant distribution tank 14e, a plurality of coolant flow paths 14f, and a coolant collection tank 14g, and it then flows out of a coolant outlet 14h.

The plurality of refrigerant flow paths 14b and the plurality of coolant flow paths 14f in the coolant cooler 14 configure the heat exchange portion that exchanges heat between the refrigerant and the coolant.

For example, the coolant cooler 14 is formed by laminating and integrally bonding, by brazing, a number of plate-shaped members and plates, each being subjected to press forming to have a fin structure for promoting heat transfer. For example, the internal heat exchanger 24 is formed by laminating and integrally bonding, by brazing, a number of plate-shaped members and plates, each being subjected to press forming to have a fin structure for promoting heat transfer.

In this embodiment, the expansion valve 23 (temperature sensing portion 23a, mechanical mechanism such as the diaphragm 23b, and throttle flow path 23c) is sandwiched and supported between the internal heat exchanger 24 and the coolant cooler 14.

Thus, a refrigerant pipe structure for connecting the expansion valve 23, coolant cooler 14, and internal heat exchanger 24 can be simplified to downsize the entire body of the cycle device, and also thereby making a pipe connection work simple.

The expansion valve 23 (temperature sensing portion 23a, mechanical mechanism such as the diaphragm 23b, and throttle flow path 23c) may be sandwiched and supported between the internal heat exchanger 24 and the coolant heater 15.

### Sixth Embodiment

In the above-mentioned fifth embodiment, the expansion valve 23 is sandwiched and supported between the coolant cooler 14 and the internal heat exchanger 24. On the other hand, in this embodiment, as shown in FIGS. 13 to 16, the expansion valve 23 is accommodated in the low-pressure side refrigerant collection tank 24g of the internal heat exchanger 24 and the refrigerant distribution tank 14a of the coolant cooler 14.

As shown in FIG. 13, the coolant cooler 14 and the internal heat exchanger 24 are integrally bonded together by brazing.

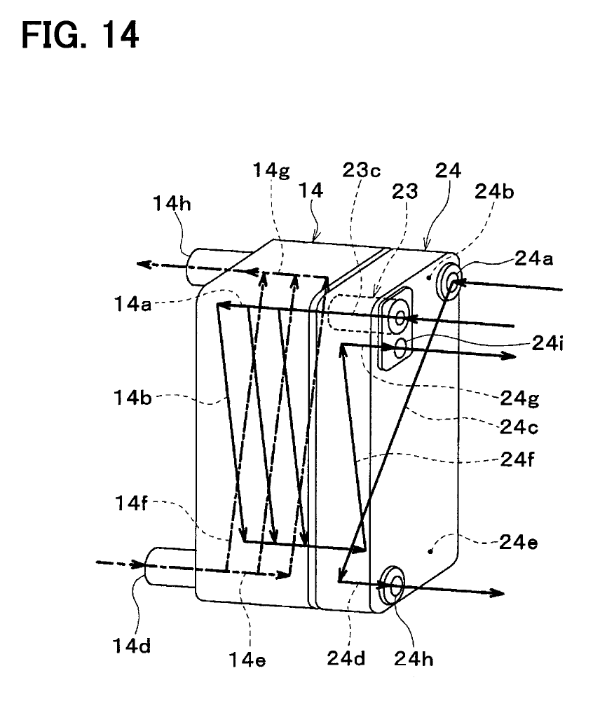

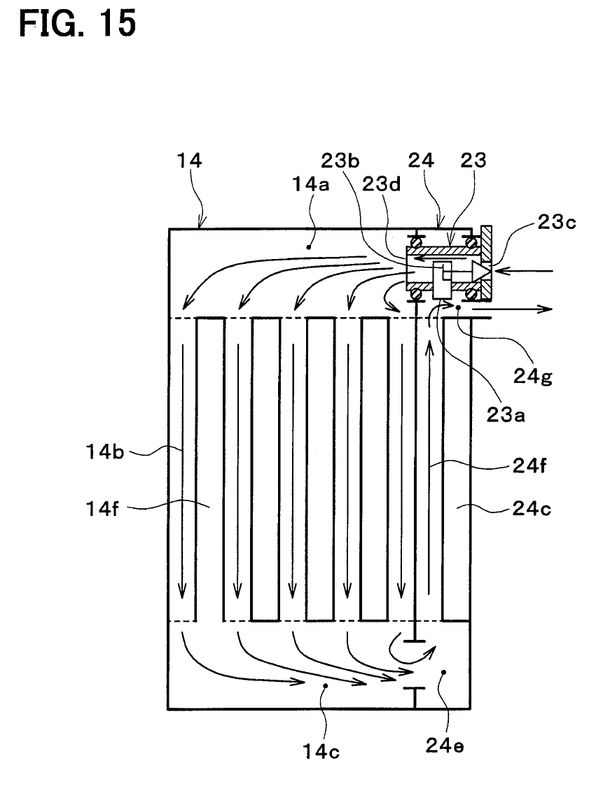

As shown in FIG. 14, the high-pressure side refrigerants collected by the high-pressure side refrigerant collection tank 24d of the internal heat exchanger 24 flow out of a high-pressure side refrigerant outlet 24h. The low-pressure side refrigerants collected by the low-pressure side refrigerant collection tank 24g of the internal heat exchanger 24 flow out of the low-pressure side refrigerant outlet 24i.

As shown in FIG. 15, the low-pressure side refrigerant collection tank 24g of the internal heat exchanger 24 and the refrigerant distribution tank 14a of the coolant cooler 14 are disposed adjacent to each other.

While the expansion valve 23 is accommodated in the low-pressure side refrigerant collection tank 24g of the internal heat exchanger 24 and the refrigerant distribution tank 14a of the coolant cooler 14, the low-pressure side refrigerant outlet 23d of the expansion valve 23 communicates with the refrigerant distribution tank 14a of the coolant cooler 14, and the temperature sensing portion 23a of the expansion valve 23 is exposed at the low-pressure side refrigerant collection tank 24g of the internal heat exchanger 24.

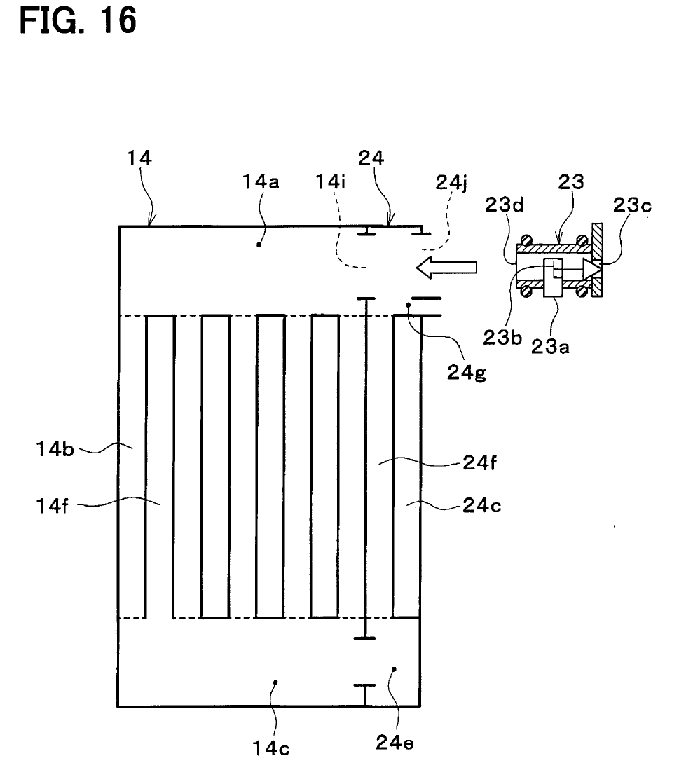

As shown in FIG. 16, the internal heat exchanger 24 and the coolant cooler 14 are provided with expansion-valve insertion holes 24j and 14i. The expansion valve 23 is inserted into the low-pressure side refrigerant collection tank 24g of the internal heat exchanger 24 and the refrigerant distribution tank 14a of the coolant cooler 14 through the expansion-valve insertion holes 24j and 14i.

This embodiment can simplify the refrigerant pipe structure for connecting the expansion valve 23, coolant cooler 14, and internal heat exchanger 24, as well as the pipe connection work.

The expansion valve 23 is accommodated in the coolant cooler 14 and the internal heat exchanger 24, thus enabling the downsizing of the entire body including the expansion valve 23, internal heat exchanger 24, and coolant cooler 14.

In this embodiment, the expansion valve 23 (temperature sensing portion 23a, the mechanical mechanism, such as the diaphragm 23b, and throttle flow path 23c) is accommodated in the refrigerant tanks 24g and 14a of the internal heat exchanger 24 and coolant cooler 14, whereby the body of the refrigeration cycle device 10 can be downsized.

That is, when the expansion valve 23 is accommodated even in one of the refrigerant collection tank 24g of the internal heat exchanger 24 and the refrigerant tank 14a of the coolant cooler 14, the body of the refrigeration cycle device 10 can be downsized, compared to when the expansion valve 23 is disposed outside the internal heat exchanger 24 and the coolant cooler 14.

Specifically, the refrigerant collection tank 24d of the internal heat exchanger 24 and the refrigerant distribution tank 14a of the coolant cooler 14 are disposed adjacent to each other, and the expansion valve 23 (temperature sensing portion 23a, the mechanical mechanism, such as the diaphragm 23b, and throttle flow path 23c) is inserted into the refrigerant collection tank 24d and refrigerant distribution tank 14a through the insertion holes 24j and 14i formed in the internal heat exchanger 24 and coolant cooler 14.

Thus, the expansion valve 23 can be accommodated in the internal heat exchanger 24 and coolant cooler 14 that are bonded together by brazing, whereby the internal heat exchanger 24, the coolant cooler 14, and the expansion valve 23 are integrated as one unit to simplify its structure.

### Other Embodiments

The above-mentioned embodiments can be appropriately combined together. Further, various modifications and changes can be made to these embodiments described above, for example, as follows.

(1) In the above-mentioned embodiments, various temperature-adjustment target devices (devices to be cooled and devices to be heated) to have their temperatures adjusted (cooled or heated) with the coolant may be disposed in the low-temperature side coolant circuit C1 and/or the high-temperature side coolant circuit C2.

The low-temperature side coolant circuit C1 and the high-temperature side coolant circuit C2 may be connected together via a switching valve. The switching valve may switch between a state of circulation for the coolant drawn and discharged by the low-temperature side pump 11 and a state of circulation for the coolant drawn and discharged by the high-temperature side pump 12, with respect to each of the plurality of temperature-adjustment target devices (heat-medium circulation devices) disposed in the low-temperature side coolant circuit C1 and/or the high-temperature side coolant circuit C2.

Furthermore, a device for heating or cooling the coolant may be disposed in the low-temperature side coolant circuit C1 and/or high-temperature side coolant circuit C2. The coolant temperature in the low-temperature side coolant circuit C1 may be prevented from becoming higher than the coolant temperature in the high-temperature side coolant circuit C2 by heating or cooling the coolant by the operation of the device for heating or cooling the coolant, or by utilizing waste heat generated in the operation of such a device.

(2) Although in each of the above-mentioned embodiments, the coolant is used as the heat medium that flows through the low-temperature side coolant circuit C1 and the high-temperature side coolant circuit C2, various kinds of media, such as oil, may be used as the heat medium.

Alternatively, nanofluid may be used as the heat medium. The nanofluid is a fluid containing nanoparticles having a diameter of the order of nanometer. By mixing the nanoparticles into the heat medium, the following functions and effects can be obtained, in addition to the function and effect of decreasing a freezing point, like a coolant (so-called antifreeze) using ethylene glycol.

That is, the use of the nanoparticles exhibits the functions and effects of improving the thermal conductivity in a specific temperature range, increasing the thermal capacity of the heat medium, preventing the corrosion of a metal pipe and the degradation of a rubber pipe, and enhancing the fluidity of the heat medium at an ultralow temperature.

These functions and effects vary depending on the composition, shape, and blending ratio of the nanoparticles, and additive material.

Thus, the mixture of nanoparticles in the heat medium can improve its thermal conductivity, whereby the same level of the cooling efficiency as that of the coolant using ethylene glycol can be exhibited with a smaller amount of the heat medium than the coolant of the ethylene glycol.

Further, such a heat medium can also improve its thermal capacity and thereby can increase a cold storage amount (cold storage due to its sensible heat) of the heat medium itself.

By increasing the cold storage amount, the temperature adjustment, including cooling and heating, of the device can be performed using the cold storage for some period of time even though the compressor 21 is not operated, which can save the power of the refrigeration cycle device 10.

An aspect ratio of the nanoparticle is preferably 50 or more. This is because such an aspect ratio can provide the adequate thermal conductivity. Note that the aspect ratio of the nanoparticle is a shape index indicating the ratio of the width to the height of the nanoparticle.

Nanoparticles suitable for use can include any one of Au, Ag, Cu, and C. Specifically, atoms configuring the nanoparticles can include an Au nanoparticle, an Ag nanowire, a carbon nanotube (CNT), a graphene, a graphite core-shell nanoparticle (a particle body, such as a structure of a carbon nanotube, that surrounds the above-mentioned atom), an Au nanoparticle-containing CNT, and the like.

(3) In the refrigerant circuit 20 of the above-mentioned embodiments, fluorocarbon refrigerant is used as the refrigerant. However, the kind of refrigerant is not limited thereto, and may be natural refrigerant, such as carbon dioxide, a hydrocarbon refrigerant, and the like.

The refrigerant circuit 20 in the above-mentioned embodiments constitutes a subcritical refrigeration cycle in which its high-pressure side refrigerant pressure does not exceed the critical pressure of the refrigerant, but may constitute a super-critical refrigeration cycle in which its high-pressure side refrigerant pressure exceeds the critical pressure of the refrigerant.

(4) In the above-mentioned embodiments, the refrigeration cycle device 10 is applied to a hybrid vehicle by way of example, but may be applied to an electric vehicle or the like that is not equipped with the engine and obtains a traveling driving force from a traveling electric motor.
(5) Although in the above-mentioned embodiments the refrigerant temperature sensor 66 detects the temperature of the low-pressure side outlet refrigerant in the internal heat exchanger 24, the refrigerant temperature sensor 66 may detect a temperature in connection with the temperature of the low-pressure side outlet refrigerant in the internal heat exchanger 24.

The refrigeration cycle may include a physical quantity detector that detects a physical quantity in connection with the temperature of the low-pressure side outlet refrigerant in the internal heat exchanger 24. The controller 50 may estimate the temperature of the low-pressure side outlet refrigerant in the internal heat exchanger 24 based on the physical quantity detected by the physical quantity detector.

(6) Although in the above-mentioned embodiments the refrigerant pressure sensor 67 detects the pressure of the low-pressure side outlet refrigerant in the internal heat exchanger 24, the refrigerant pressure sensor 67 may detect a pressure in connection the pressure of the low-pressure side outlet refrigerant in the internal heat exchanger 24.

The refrigeration cycle may include a physical quantity detector that detects a physical quantity in connection with the pressure of the low-pressure side outlet refrigerant in the internal heat exchanger 24. The controller 50 may estimate the pressure of the low-pressure side outlet refrigerant in the internal heat exchanger 24 based on the physical quantity detected by the physical quantity detector.

(7) Although in the above-mentioned embodiments the refrigerant temperature sensor 71 detects the temperature of the outlet side high-pressure refrigerant in the internal heat exchanger 24, the refrigerant temperature sensor 71 may detect a temperature in connection with the temperature of the outlet side high-pressure refrigerant in the internal heat exchanger 24.

The refrigeration cycle may include a physical quantity detector that detects a physical quantity in connection with the temperature of the outlet side high-pressure refrigerant in the internal heat exchanger 24. The controller 50 may estimate the temperature of the outlet side high-pressure refrigerant in the internal heat exchanger 24 based on the physical quantity detected by the physical quantity detector.

(8) Although in the above-mentioned embodiments the refrigerant pressure sensor 72 detects the pressure of the outlet side high-pressure refrigerant in the internal heat exchanger 24, the refrigerant pressure sensor 72 may detect a pressure in connection with the pressure of the outlet side high-pressure refrigerant in the internal heat exchanger 24.

The refrigeration cycle may include a physical quantity detector that detects a physical quantity in connection with the pressure of the outlet side high-pressure refrigerant in the internal heat exchanger 24. The controller 50 may estimate the pressure of the outlet side high-pressure refrigerant in the internal heat exchanger 24 based on the physical quantity detected by the physical quantity detector.

(9) In the above-mentioned embodiments, the internal heat exchanger 24 may have a double-piped structure. The coolant cooler 14 and the coolant heater 15 may be arranged such that one side of the coolant cooler is in contact with one side of the coolant heater, thereby causing the contact sides to act as the internal heat exchanger.

1. A refrigeration cycle device comprising:
a low-temperature side pump that draws and discharges a low-temperature side heat medium;
a compressor that draws, compresses, and discharges a refrigerant;
a heat radiation device that dissipates heat from the high-pressure refrigerant discharged from the compressor;
a decompression device that decompresses the high-pressure refrigerant having heat dissipated by the heat radiation device;
a heat-medium cooler that cools the low-temperature side heat medium by exchanging heat between the low-pressure refrigerant decompressed by the decompression device and the low-temperature side heat medium;
a heat medium-air heat exchanger that exchanges heat between the heat medium cooled by the heat-medium cooler and air;
an internal heat exchanger that exchanges heat between the high-pressure refrigerant flowing out of the heat radiation device and the low-pressure refrigerant flowing out of the heat-medium cooler;
a low-pressure refrigerant temperature sensing portion that detects or senses a temperature in connection with a temperature of the low-pressure refrigerant having heat exchanged in the internal heat exchanger; and
a superheat-degree control unit that controls a degree of superheat of the low-pressure refrigerant having heat exchanged in the internal heat exchanger, based on the temperature detected or sensed by the low-pressure refrigerant temperature sensing portion.

2. The refrigeration cycle device according to claim 1, wherein
the superheat-degree control unit decreases the degree of superheat of the low-pressure refrigerant having heat exchanged in the internal heat exchanger when a temperature or pressure of the low-pressure side refrigerant is decreased.

3. The refrigeration cycle device according to claim 1, further comprising:
a high-temperature side pump that draws and discharges a high-temperature side heat medium; and
a heat-medium temperature control unit that controls a temperature of at least one of the low-temperature side heat medium and the high-temperature side heat medium, wherein
the heat radiation device exchanges heat between the high-pressure refrigerant discharged from the compressor and the high-temperature side heat medium, and
the heat-medium temperature control unit decreases a temperature of the low-temperature side heat medium or increases a temperature of the high-temperature side heat medium (i) when a difference in temperature between the high-temperature side heat medium and the low-temperature side heat medium is determined or estimated to be smaller than a predetermined degree, or (ii) when the temperature of the high-temperature side heat medium is determined or estimated to be lower than that of the low-temperature side heat medium.

4. The refrigeration cycle device according to claim 1, further comprising:
a radiator that exchanges heat between the low-temperature side heat medium and outside air, wherein
the heat radiation device includes an air-heating heat exchanger that heats ventilation air to be blown into a space to be air-conditioned.

5. The refrigeration cycle device according to claim 3, further comprising:
a radiator that exchanges heat between the high-temperature side heat medium and outside air; and
a heat-medium flow-rate adjustment portion that adjusts a flow rate of the high-temperature side heat medium between the radiator and the heat radiation device, wherein
the heat-medium temperature control unit controls an operation of the heat-medium flow-rate adjustment portion so as to increase the temperature of the high-temperature side heat medium, by decreasing a flow rate of the high-temperature side heat medium between the radiator and the heat radiation device, (i) when a difference between the temperature of the high-temperature side heat medium and the temperature of the low-temperature side heat medium is determined or estimated to be smaller than the predetermined degree, or (ii) when the temperature of the high-temperature side heat medium is determined or estimated to be lower than that of the low-temperature side heat medium.

6. The refrigeration cycle device according to claim 3, further comprising:
a radiator that exchanges heat between outside air and the high-temperature side heat medium or the low-temperature side heat medium, and
a heat-medium switch that selectively switches between a state in which the high-temperature side heat medium passing through the heat radiation device flows to the radiator and a state in which the low-temperature side heat medium passing through the heat-medium cooler flows to the radiator.

7. The refrigeration cycle device according to claim 1, wherein
the superheat-degree control unit controls a state of the refrigerant to prevent occurrence of the degree of superheat, when a pressure of the low-pressure refrigerant having heat exchanged in the internal heat exchanger is lower than a saturated pressure of the refrigerant at a predetermined temperature.

8. The refrigeration cycle device according to claim 1, wherein
the low-pressure refrigerant temperature sensing portion includes a temperature sensing portion into which a gas medium is charged, the gas medium having a pressure increased in accordance with an increase in temperature of the low-pressure refrigerant having heat exchanged in the internal heat exchanger,
the superheat-degree control unit has a mechanical mechanism that increases an opening degree of the decompression device with an increasing pressure of the gas medium in the temperature sensing portion,
temperature-pressure characteristics of the gas medium differ from temperature-pressure characteristics of the refrigerant, and
a valve-opening characteristic of the decompression device in the mechanical mechanism exhibits a cross-charge characteristic that intersects a saturation line of the refrigerant in a predetermined pressure range.

9. The refrigeration cycle device according to claim 1, wherein
the low-pressure refrigerant temperature sensing portion includes a refrigerant temperature sensor that detects the temperature in connection with the temperature of the low-pressure refrigerant having heat exchanged in the internal heat exchanger, and
the superheat-degree control unit includes an electric mechanism that changes an opening degree of the decompression device, and a controller that controls an operation of the electric mechanism based on the temperature detected by the refrigerant temperature sensor.

10. The refrigeration cycle device according to claim 1, further comprising:
an accumulator that stores therein the low-pressure side refrigerant having heat exchanged in the internal heat exchanger;
a high-pressure refrigerant temperature detector that detects a temperature in connection with the temperature of the high-pressure refrigerant having heat exchanged in the internal heat exchanger; and
a supercooling-degree control unit that controls a degree of supercooling of the high-pressure refrigerant having heat exchanged in the internal heat exchanger, based on the temperature detected by the high-pressure refrigerant temperature detector.
